(19) United States
(12) Patent Application Publication
(10) Pub. No.: US 2026/0129677 A1
(43) Pub. Date: May 7, 2026

(54) NON-PRIMARY CHANNEL ACCESS CONDITIONS FOR JOINT OPERATION WITH COORDINATED ACCESS POINT PROCEDURES

(71) Applicant: QUALCOMM Incorporated, San Diego, CA (US)

(72) Inventors: Sherief HELWA, San Diego, CA (US); Gaurang NAIK, San Diego, CA (US); Abhishek Pramod PATIL, San Diego, CA (US); George CHERIAN, San Diego, CA (US); Youhan KIM, Saratoga, CA (US); Srinivas KATAR, Fremont, CA (US); Alfred ASTERJADHI, San Diego, CA (US); Sanket Sanjay KALAMKAR, San Diego, CA (US); Giovanni CHISCI, San Diego, CA (US); Sai Yiu Duncan HO, San Diego, CA (US)

(21) Appl. No.: 19/379,298

(22) Filed: Nov. 4, 2025

Related U.S. Application Data
(60) Provisional application No. 63/716,836, filed on Nov. 6, 2024.

(51) Int. Cl. H04W 74/0808

(52) U.S. Cl. CPC H04W 74/0808

(57) ABSTRACT

This disclosure provides methods, components, devices and systems for non-primary channel access (NPCA) conditions for joint operation with coordinated access point (AP) procedures. Some aspects more specifically relate to preventing an NPCA-enabled station from switching to the secondary primary channel during a coordinated transmission messaging sequence. In some examples, a first AP may transmit, to the NPCA-enabled station, a first frame that indicates one or more parameters associated with a determination of whether to transition from the first primary channel to a secondary primary channel. Based on receiving the indication of the one or more parameters, the NPCA-enabled station may determine not to switch to the secondary primary channel, and may complete the coordinated transmission messaging sequence.

### CROSS REFERENCES

The present Application for Patent claims benefit of U.S. Provisional Patent Application No. 63/716,836 by HELWA et al., entitled “NON-PRIMARY CHANNEL ACCESS CONDITIONS FOR JOINT OPERATION WITH COORDINATED ACCESS POINT PROCEDURES,” filed Nov. 6, 2024, assigned to the assignee hereof, and expressly incorporated herein.

### TECHNICAL FIELD

This disclosure relates generally to wireless communication and, more specifically, to non-primary channel access conditions for joint operation with coordinated access point procedures.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by a first access point (AP). The method may include transmitting, to one or more stations (STAs) via a first primary channel, a first frame associated with a coordinated transmission messaging sequence by the first AP and a second AP, where the first frame indicates one or more parameters associated with a determination of whether to transition from the first primary channel to a secondary primary channel, and where the secondary primary channel is used for contending for channel access when the first primary channel is occupied and communicating one or more subsequent frames associated with the coordinated transmission messaging sequence on the first primary channel in accordance with the one or more parameters.

Another innovative aspect of the subject matter in this disclosure can be implemented in a first AP for wireless communications. The first AP may include a processing system that includes processor circuitry and memory circuitry that stores code. The processing system may be configured to cause the first AP to transmit, to one or more STAs via a first primary channel, a first frame associated with a coordinated transmission messaging sequence by the first AP and a second AP, where the first frame indicates one or more parameters associated with a determination of whether to transition from the first primary channel to a secondary primary channel, and where the secondary primary channel is used for contending for channel access when the first primary channel is occupied and communicate one or more subsequent frames associated with the coordinated transmission messaging sequence on the first primary channel in accordance with the one or more parameters.

An innovative aspect of the subject matter in this disclosure can be implemented in another first AP for wireless communications. The first AP may include means for transmitting, to one or more STAs via a first primary channel, a first frame associated with a coordinated transmission messaging sequence by the first AP and a second AP, where the first frame indicates one or more parameters associated with a determination of whether to transition from the first primary channel to a secondary primary channel, and where the secondary primary channel is used for contending for channel access when the first primary channel is occupied and means for communicating one or more subsequent frames associated with the coordinated transmission messaging sequence on the first primary channel in accordance with the one or more parameters.

Another innovative aspect of the subject matter in this disclosure can be implemented in a non-transitory computer-readable medium storing code for wireless communications. The code may include instructions executable by one or more processors to transmit, to one or more STAs via a first primary channel, a first frame associated with a coordinated transmission messaging sequence by the first AP and a second AP, where the first frame indicates one or more parameters associated with a determination of whether to transition from the first primary channel to a secondary primary channel, and where the secondary primary channel is used for contending for channel access when the first primary channel is occupied and communicate one or more subsequent frames associated with the coordinated transmission messaging sequence on the first primary channel in accordance with the one or more parameters.

In some examples of the method, first APs, and non-transitory computer-readable medium described herein, a parameter of the one or more parameters indicates a first duration for providing network allocation vector protection and the first duration may be less than a channel switching threshold duration corresponding to transition between the first primary channel and the secondary primary channel.

Some examples of the method, first APs, and non-transitory computer-readable medium described herein may further include operations, features, means, or instructions for transmitting, to the one or more STAs via the first primary channel, a multi-user block acknowledgment request corresponding to a downlink data transmission of the coordinated transmission messaging sequence, the multi-user block acknowledgment request indicating a first duration of network allocation vector protection, and monitoring the first primary channel for a block acknowledgment responsive to the multi-user block acknowledgment request.

In some examples of the method, first APs, and non-transitory computer-readable medium described herein, a parameter of the one or more parameters indicates a first bandwidth associated with the coordinated transmission messaging sequence that includes the first primary channel and the secondary primary channel and the one or more subsequent frames may be communicated via the first bandwidth or via a second bandwidth that differs from the first bandwidth.

In some examples of the method, first APs, and non-transitory computer-readable medium described herein, a parameter of the one or more parameters includes an indication that a non-primary channel access operation may be disallowed or disabled during the coordinated transmission messaging sequence by the first AP and the second AP, the non-primary channel access operation associated with transition between the first primary channel and the secondary primary channel.

In some examples of the method, first APs, and non-transitory computer-readable medium described herein, the coordinated transmission messaging sequence may be a coordinated beamforming channel sounding sequence or a coordinated beamforming data transmission sequence and the method, apparatuses, and non-transitory computer-readable medium may include further operations, features, means, or instructions for transmitting, to the second AP, an invitation to perform the coordinated beamforming channel sounding sequence or the coordinated beamforming data transmission sequence and monitoring for a response indicating an acceptance or a rejection of the invitation.

In some examples of the method, first APs, and non-transitory computer-readable medium described herein, the transition from the first primary channel to the secondary primary channel may be delayed until after reception of an initial control frame, an initial control response frame, and a third frame.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example of a signaling diagram that supports non-primary channel access (NPCA) conditions for joint operation with coordinated access point (AP) procedures.

FIG. 3 shows an example of a time-frequency diagram that supports NPCA conditions for joint operation with coordinated AP procedures.

FIGS. 4, 5, and 6 show examples of signaling diagrams that support NPCA conditions for joint operation with coordinated AP procedures.

FIG. 7 shows a block diagram of an example wireless communication device that supports NPCA conditions for joint operation with coordinated AP procedures.

FIGS. 8 and 9 show flowcharts illustrating example processes performable by or at a first AP that supports NPCA conditions for joint operation with coordinated AP procedures.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Some wireless communication networks may support coordinated transmission messaging sequences in which two or more access points (APs) simultaneously use the medium in two or more basic service sets (BSSs). For example, a coordinated transmission messaging sequence may include a coordinated beamforming (CoBF) operation that includes a channel sounding phase to make channel state information (CSI) available at each AP and a transmission phase, where the two or more APs agree on which client STAs will be served and synchronize transmissions. A bandwidth of the medium associated with a BSS may include a first primary channel and one or more secondary channels. In some wireless communication networks, one or more stations (STAs) may contend for access to the medium using the first primary channel. STAs that support non-primary channel access (NPCA) operation may switch from the first primary channel to a secondary primary channel to contend for access to the medium if the first primary channel is occupied. In some examples, to perform the coordinated transmission messaging sequences, one or more STAs and one or more corresponding APs may exchange one or more initial control frames (ICFs) and initial control responses (ICRs) to prepare the one or more STAs to receive data. However, one or more NPCA-enabled STAs may detect an ICF/ICR exchange for a first part of a coordinated transmission messaging sequence, interpret that the first primary channel is occupied, and switch to the secondary primary channel before a second part of the coordinated transmission messaging sequence is completed. That is, the NPCA-enabled STAs may not receive an ICF from their corresponding AP, and the coordinated transmission messaging sequence may fail.

Various aspects relate generally to preventing an NPCA-enabled STA from switching to the secondary primary channel during coordinated transmission messaging sequences. Some aspects more specifically relate to a first AP transmitting, to one or more STAs via the first primary channel, a first frame that indicates one or more parameters associated with a determination of whether to transition from the first primary channel to a secondary primary channel. In some examples, the one or more STAs may determine not to switch to the secondary primary channels based on the one or more parameters. Accordingly, by indicating the one or more parameters to the one or more STAs, coordinated transmission messaging sequences may be completed.

In some examples, a parameter of the one or more parameters may indicate a first bandwidth associated with the coordinated transmission messaging sequence that spans the first primary channel and the second primary channel, and the one or more STAs may determine that the secondary primary channel is busy (or occupied), and may not switch to the secondary primary channel. Additionally, or alternatively, a parameter of the one or more parameters may indicate a first duration for providing network allocation vector (NAV) protection, and the one or more STAs may determine that the first primary channel will be occupied for a relatively short duration (such as less than a channel switching threshold duration), and may not switch to the secondary primary channel. In some other examples, the first AP may transmit a multi-user block acknowledgment request (MU-BAR) indicating a duration for providing NAV protection, and the one or more STAs may determine that the first primary channel will be occupied for a relatively short duration (such as less than a channel switching threshold duration), and may not switch to the secondary primary channel.

In some other examples, a parameter of the one or more parameters may indicate that a NPCA operation may be disallowed or disabled during the coordinated transmission messaging sequence by the first AP. Additionally, or alternatively, the coordinated transmission messaging sequence may be a coordinated beamforming channel sounding sequence or a coordinated beamforming data transmission sequence, and the second AP may accept or reject an invitation from the first AP to perform the coordinated beamforming channel sounding sequence or the coordinated beamforming data transmission sequence.

Although some aspects of the present disclosure are described in the context of non-primary channel access, with a first primary channel and one or more second primary channels, it may be understood that the concepts and techniques described herein apply more broadly to any type of system with different types of channels or links used to contend for channel access. In some implementations, the techniques described herein may be applied in systems where the first primary channel and the second primary channel are sub channels within an operating bandwidth (such as in non-primary channel access). In some other implementations, the techniques described herein may be applied where the first primary channel and the second primary channel are different links (such as in enhanced multi-link single radio (eMLSR) AP systems).

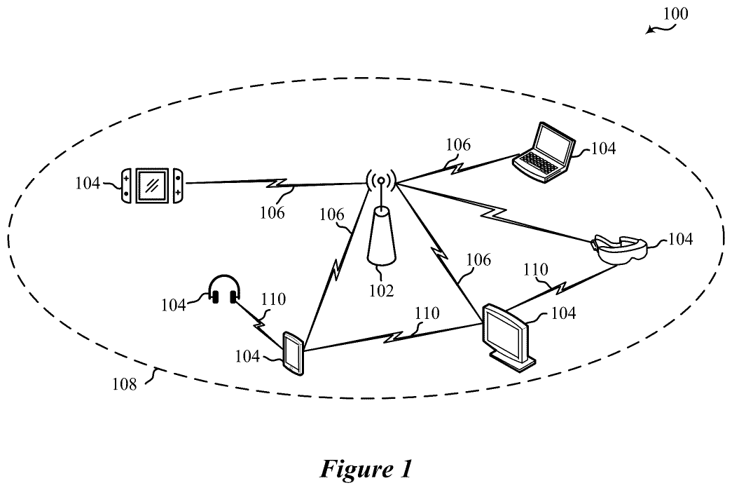

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102.

FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. In some other examples, second primary channels may each be referred to as an NPCA Primary channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel (e.g., an NPCA Primary channel). In some examples, the M-Primary channel may be used for beaconing and serving legacy client devices and an O-Primary channel (e.g., an NPCA Primary channel) may be specifically used by non-legacy (such as UHR-or IEEE 802.11bn-compatible) devices for opportunistic access to spectrum that may be otherwise under-utilized.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and Ultra-High Reliability (UHR) operation defined by the IEEE 802.11bn standard amendments, to enable additional capabilities or features relative to previous generations, such as devices supporting only legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz while a UHR system may enable communications spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

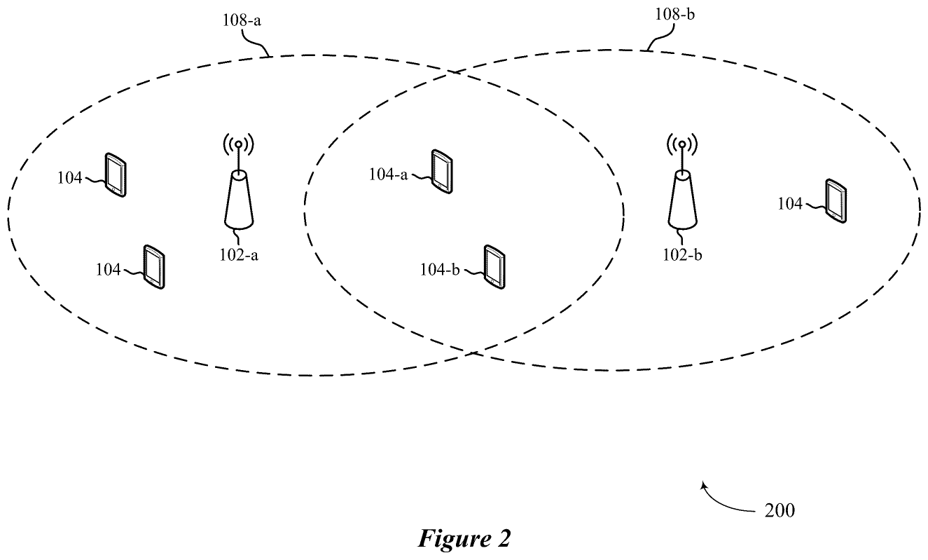

FIG. 2 shows an example of a signaling diagram 200 that supports non-primary channel access conditions for joint operation with coordinated AP procedures. In some examples, the signaling diagram 200 may implement or be implemented by aspects of the wireless communication network 100. For example, the signaling diagram 200 may include a first AP 102-a, a second AP 102-b, a first STA 104-a, a second STA 104-b, and one or more other STAs 104, which may be examples of corresponding devices described herein with reference to FIG. 1. Additionally, or alternatively, the APs 102 and the STAs 104 may each be examples of other types of wireless devices, such as a BS, a UE, or another type of transmitter or receiver. Thus, although aspects of the present disclosure are described with reference to APs 102 and STAs 104, it is understood that the described techniques may be performed by a wireless device different from an AP 102 and a STA 104. As described herein, operations performed by the APs 102 and the STAs 104 may be respectively performed by an AP 102, a STA 104, or another wireless device, and the examples shown should not be construed as limiting. Additionally, or alternatively, while two APs 102 and five STAs 104 are shown in the signaling diagram 200, more devices or fewer devices may be possible and the examples shown should not be construed as limiting.

Each of the first AP 102-a and the second AP 102-b may be associated with a respective BSS (such as a first BSS and a second BSS, respectively), where each BSS includes one or more STAs 104. For example, the first BSS may include one or more devices within a first coverage area 108-a (such as the AP 102-a, the STA 104-a, the STA 104-b, and one or more other STAs 104). Similarly, the second BSS may include one or more devices within a second coverage area 108-b (such as the AP 102-b, the STA 104-a, the STA 104-b, and one or more other STAs 104). The STAs 104 may be connected to the first AP 102-a, the second AP 102-b, or both via a communication link 106. In some examples, the first BSS and the second BSS may be overlapping to form an OBSS. For example, the STA 104-a and the STA 104-b may be included in both the first BSS and the second BSS, and may therefore be part of an OBSS associated with the first AP 102-a and the second AP 102-b. In some examples, the first AP 102-a may be a sharing AP and the second AP 102-b may be a shared AP, as discussed with reference to FIG. 1. In some other examples, the first AP 102-a may be a Coordinating AP and the second AP 102-b may be a Coordinated AP, as discussed with reference to FIG. 1.

In some examples, devices in the signaling diagram 200 may support one or more CoBF operations. A CoBF operation may be a coordinated AP scheme that aims at simultaneously using a medium (such as a wireless channel) in two or more BSSs to maximize the system throughput. In some examples, the CoBF operation may exploit one or more hardware capabilities of the AP 102-a and the AP 102-b (such as larger antenna arrays) to actively null signals at one or more clients of the OBSS using transmission beamforming. For example, the first AP 102-a may create a null at the second STA 104-b associated with the second AP 102-b and the second BSS, and the second AP 102-b may create a null at the first STA 104-a associated with the first AP 102-a and the first BSS. In this way, OBSS interference may be limited and successful reception may be achieved. However, to perform such a CoBF operation, transmitting devices (such as the first AP 102-a and the second AP 102-b) may have CSI knowledge (such as may know CSI information). For example, the AP 102-a may perform the CoBF operation based on knowing the channel estimate between the AP 102-a and an associated client (such as STA 104) as well as between the AP 102-a and the OBSS client (such as the STA 104-a). The AP 102-a may be unable to perform the CoBF operation without such channel estimates.

A CoBF operation may be divided into two main phases: a channel sounding phase (such as CSI estimate collection) and a transmission phase (such as initial negotiation and initial handshaking between the first AP 102-a and the second AP 102-b in addition to data transmission). The objective of the channel sounding phase may be to make the CSI available at the OBSS APs 102 so that the OBSS AP 102 may actively null a signal at the OBSS client. For example, as a result of the channel sounding phase, the first AP 102-a may null an associated signal at the STA 104-b and the second AP 102-b may null an associated signal at the STA 104-a to reduce interference. During the transmission phase of the CoBF operation, the first AP 102-a and the second AP 102-b (and any other APs 102 that may contribute to the OBSS) may agree on which clients (such as STAs 104) will be served by which AP 102, synchronize with each device, and proceed with simultaneous data transmission. During the simultaneous data transmission, the first AP 102-a and the second AP 102-b may use the CSI collected during the channel sounding phase in order to create the nulls in each respective signal.

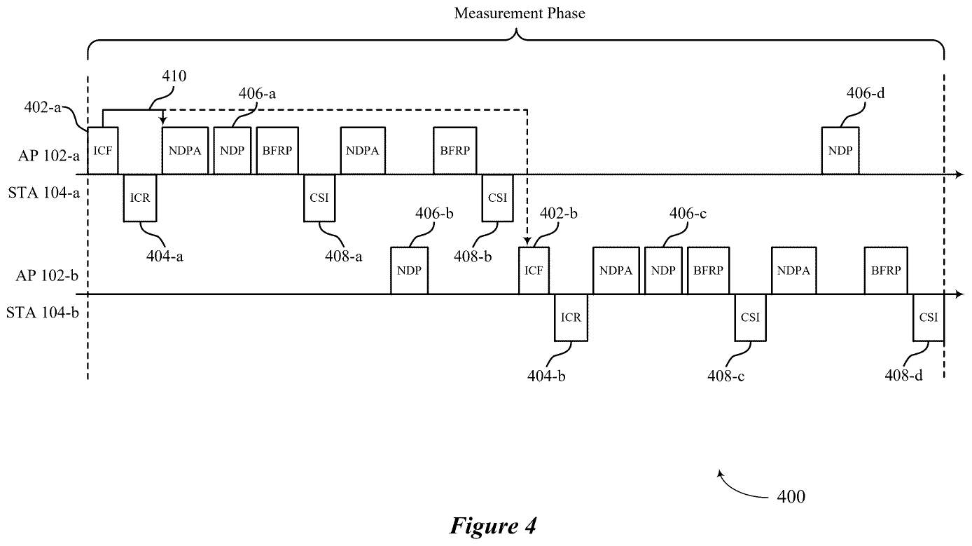

The channel sounding phase of the CoBF operation may be a collaborative process performed by two or more APs 102 to collect CSI between each AP 102 and the OBSS clients (such as STAs 104). The general procedures of CoBF channel sounding may follow the same concept of legacy in-BSS CoBF channel sounding using the NDPA-NDP-BFRP-CSI frame sequence, as illustrated by at least FIG. 4.

CoBF channel sounding may be sequential or joint. In sequential channel sounding, sounding is first performed for an associated AP 102 (such as the first AP 102-a) by transmitting a null data packet (NDP) and receiving CSI in response to a beamforming report (BFRP) frame. Second sounding is performed for an OBSS AP 102 (such as the second AP 102-b). For example, the associated AP 102-a may transmit a null data packet announcement (NDPA) on behalf of the OBSS AP 102-b. The OBSS AP 102-b may transmit an NDP followed by a BFRP frame sent by the associated AP 102-a on behalf of the OBSS AP 102-b. Finally, the client (such as the AP 102) may report back associated CSI. The sequential sounding process may be repeated for all APs 102 participating in the channel sounding process.

Joint channel sounding, in contrast, may aim to perform the sounding process in a more efficient way by performing CSI estimation to the associated AP 102-a as well as the OBSS AP 102-b simultaneously. A similar sounding sequence to that of sequential sounding may be used, but with the following differences. In joint channel sounding, one or more NDP frames may be sent jointly by both APs 102 at the same time. In such cases, CSI estimation to the two APs 102 can be done using a separate set of LTFs. Joint channel sounding may save up to three frame exchanges per AP 102 compared to sequential channel sounding, which may reduce the overhead of the sounding sequence.

During the transmission phase of the CoBF operation, the two or more APs 102 may agree on which clients (such as STAs 104) will be served by each AP 102 during a shared TXOP and whether or not each AP 102 can null an associated transmission signal at the one or more clients of the other AP 102. Such an agreement may be achieved by means of the following three-way handshaking sequence. First, the first AP 102-a (such as a sharing AP or a Coordinating AP) may share common preamble information in addition to which client (such as the first STA 104-a) or clients the first AP 102-a will serve via a CoBF trigger frame (such as the CoBF trigger frame may be associated with triggering one or more STAs 104 to transition from a first operating state to a second operating state). The sharing AP (e.g., the Coordinating AP) may own the shared TXOP. For example, in order to generate a common portion of later downlink PPDUs (such as CoBF messaging) at the first AP 102-a and the second AP 102-b with at least a portion of the file headers in common, the APs 102 may agree on one or more parameters. Second, the second AP 102-b (such as a shared AP or a Coordinated AP) may acknowledge that the second AP 102-b can null an associated signal at the first AP 102-a client (such as the first STA 104-a) and declares which client the second AP 102-b will serve (such as the second STA 104-b) via a CoBF response frame (such as based on the CoBF trigger frame). The shared AP (e.g., the Coordinated AP) may use the shared TXOP. Third, the first AP 102-a may acknowledge that the second AP 102-b can null an associated signal at the second AP 102-b client (such as the second STA 104-b) via an ACK/Sync frame. The ACK/Sync frame may be used for synchronizing data transmissions, sharing information for creating a common preamble for downlink PPDUs, or both.

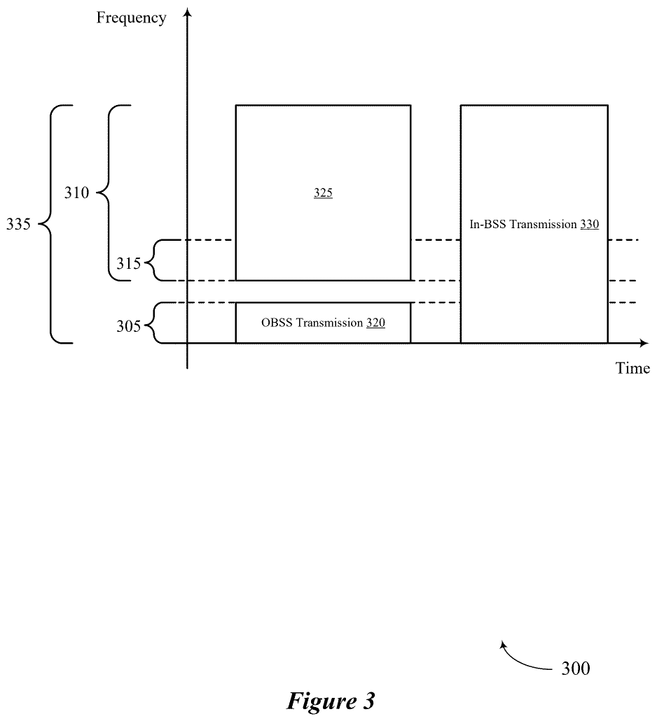

In some examples, one or more STAs 104 within the first BSS and one or more STAs 104 within the second BSS may support NPCA operations during CoBF operations, such as the sounding phase or the transmission phase. Some wireless communications networks may support relatively large operating bandwidths (as large as 320 MHz). Within the operating bandwidth, a 20 MHz channel may be designated as a primary channel (such as primary 20 MHz, BSS Primary, Main Primary, M-Primary or M-Primary channel), while the remaining bandwidth may be divided into secondary channels. Devices that do not support NPCA may contend for access on the primary channel, while the secondary channels are unused (such as because access to the operating bandwidth may be contingent on access to the primary channel). NPCA-enabled devices may support monitoring additional 20 MHz primary channels, referred to as Opportunistic Primary (O-Primary), NPCA Primary, anchor channel, or temporary primary channels within the operating bandwidth, such as the secondary channels. For example, a STA 104 that supports NPCA may detect that a first primary channel is occupied (such as detect transmissions from another STA 104 or AP 102 in the channel) and switch to a secondary primary channel. Additional details related to NPCA are described in further detail herein with reference to FIG. 3.

In some examples, one or more of the STAs 104 may be an enhanced multi-link single radio (eMLSR) STA, may be in a CoEx mode, may be in a dynamic-power saving (DPS) mode, or any combination thereof. In such examples, the one or more STAs 104 may exchange one or more initial control frames (ICFs) and one or more initial control responses (ICRs) with an in-BSS AP 102 to prepare for a coordinated transmission messaging sequence, such as a channel sounding sequence, a transmission sequence, or both of a CoBF operation. For example, the channel sounding phase of the CoBF operation (which may be a sequential sounding operation or a joint sounding operation) may include two or more channel sounding sequences. During each channel sounding sequence of the channel sounding phase of the CoBF operation, an AP 102 may transmit one or more ICFs to one or more STAs 104 requesting the one or more STAs 104 to prepare to receive one or more frames as part of the channel sounding sequence. The one or more STAs 104 may respond to the one or more ICFs with one or more ICRs acknowledging the ICF, indicating unavailability information, indicating that the one or more STAs 104 are prepared to receive the one or more frames as part of the channel sounding sequence, or a combination thereof. As a result of the channel sounding phase, each AP 102 in the OBSS may have CSI associated with each of the one or more STAs 104, which may be used to determine which clients will be served by which AP 102. During the transmission phase of the CoBF operation, an ICF/ICR exchange may take place between each AP 102 and one or more associated STAs 104 to prepare the one or more associated STAs 104 for reception of a downlink PPDU.

In some examples, however, an ICF/ICR frame exchange in the first BSS may cause a STA 104 (such as a STA 104 that supports NPCA) in the second BSS to switch to the secondary primary channel because it may interpret the ICF/ICR exchange as an indication that the first primary channel will be busy. Based on switching to the secondary primary channel, the STA 104 may not receive signaling for its corresponding CoBF channel sounding or transmission sequence on the first primary channel, as described further with reference to FIGS. 3 and 4. Failing to receive the signaling may result in the coordinated transmission messaging sequence to fail.

As described herein, an NPCA-enabled STA 104 may not switch to a second primary channel during a coordinated transmission messaging sequence, such as a CoBF operation. For example, the first AP 102-a may transmit, to at least the first STA 104-a and to the NPCA-enabled STA 104 via the first primary channel, a first frame associated with the coordinated transmission messaging sequence by the first AP 102-a and the second AP 102-b. The first frame may indicate one or more parameters associated with a determination of whether to transition from the first primary channel to the secondary primary channel. In some examples, the first AP 102-a may communicate one or more subsequent frames associated with the coordinated transmission messaging sequence on the first primary channel in accordance with the one or more parameters.

FIG. 3 shows an example of a time-frequency diagram 300 that supports NPCA conditions for joint operation with coordinated AP procedures. The time-frequency diagram 300 may implement or be implemented by aspects of the wireless communication network 100 or the signaling diagram 200, as described with reference to FIGS. 1 and 2. For example, one or more STAs 104 and one or more APs 102 may communicate over an operating bandwidth 335 that includes a primary channel 305 (such as M-Primary) and one or more secondary channels 310. In some examples, the primary channel 305 may span 20 MHz of the operating bandwidth 335. The one or more secondary channels 310 may include multiple subchannels. The subchannels may span different bandwidths. For example, the one or more secondary channels 310 may include a 20 MHz subchannel, a 40 MHz subchannel, or an 80 MHz subchannel (such as for a 160 MHz operating bandwidth).

In some examples, devices that do not support NPCA or multi-primary channel access may contend for access to the operating bandwidth 335 on the primary channel 305. That is, access to the operating bandwidth 335 may be contingent on access to the primary channel 305 (no matter how wide the operating bandwidth is). Based on accessing the primary channel 305, devices may access the remaining available portions of the operating bandwidth 335. For example, based on accessing the primary channel 305, devices may communicate in-BSS transmissions 330 using the primary channel 305, the one or more secondary channels 310, or any combination thereof. In some examples, if an OBSS STA 104 occupies the primary channel 305, the remainder of the operating bandwidth 335 (such as the one or more secondary channels 310) may be unutilized by devices that do not support NPCA, which may contribute to lower throughput and longer latencies. For example, if OBSS transmissions 320 occur in the primary channel 305 (such as if the primary channel 305 is busy), a device that does not support NPCA may be unable to contend for any resources in the remaining bandwidth 325.

Devices that do support NPCA (such as an UHR device or NPCA-enabled device) may be capable of monitoring additional 20 MHz primary channels within the operating bandwidth 335. As described herein, the primary channel 305 may be referred to as the main primary (M-Primary) channel, and the additional primary channels supported by NPCA-enabled devices may be referred to as Opportunistic Primary (O-Primary) channels, NPCA Primary channels, or secondary primary channels. For example, a device, such as a STA 104, that supports NPCA may detect that the M-Primary channel 305 is occupied by one or more OBSS transmissions 320, switch to a secondary primary channel 315 within the one or more secondary channels 310, and contend for access to the operating bandwidth 335 on the secondary primary channel 315.

In one example, a transmitting device that supports NPCA (such as a STA 104), may detect the one or more OBSS transmissions 320, such as an OBSS PPDU, in the M-Primary channel 305. Based on detecting the one or more OBSS transmissions 320, the transmitting device may switch to the secondary primary channel 315 (such as the O-Primary channel or the NPCA Primary channel). After switching to the secondary primary channel 315, the transmitting device may transmit one or more RTS frames and (based on the RTS frames) receive one or more clear-to-send (CTS) frames. Based on receiving the one or more CTS frames, the transmitting device may transmit a PPDU (such as to an AP 102). For example, the PPDU may be an in-BSS PPDU. In some examples, the transmitting device may receive a feedback message (such as an ACK) based on transmitting the PPDU.

In a second example, a receiving device that supports NPCA (such as a STA 104) may detect the one or more OBSS transmissions 320, such as an OBSS PPDU, in the M-Primary channel 305. Based on detecting the one or more OBSS transmissions 320, the receiving device may switch to the secondary primary channel 315. After switching to the secondary primary channel 315, the receiving device may receive one or more RTS frames and (such as based on the RTS frames) transmit one or more CTS frames. Based on transmitting the one or more CTS frames, the receiving device may receive a PPDU (such as from an AP 102). In some examples, the receiving device may transmit a feedback message (such as an ACK) based on receiving the PPDU.

In some examples, as described further with reference to FIGS. 3 and 4, an ICF/ICR frame exchange during a coordinated transmission messaging sequence in the first BSS may cause a STA 104 (such as an NPCA-enabled STA 104) in the second BSS to switch to the secondary primary channel 315 because it may interpret the ICF/ICR exchange as an indication that the M-Primary channel 305 is busy. Based on switching to the secondary primary channel 315, the STA 104 may not receive signaling for its portion of the coordinated transmission messaging sequence on the M-Primary channel. The techniques described herein support an NPCA-enabled STA 104 to avoid switching to an O-Primary channel (e.g., an NPCA Primary channel) during a coordinated transmission messaging sequence (such as a coordinated AP procedure).

FIG. 4 shows an example of a signaling diagram 400 that supports NPCA conditions for joint operation with coordinated AP procedures. In some examples, the signaling diagram 400 may implement aspects of the wireless communications network 100, the signaling diagram 200, and the time-frequency diagram 300. For example, the signaling diagram 400 includes a first AP 102-a, a second AP 102-b, a first STA 104-a, a second STA 104-b, which may be examples of the corresponding devices described with reference to FIG. 1. In some examples, steps in the signaling diagram 400 may include additional features not mentioned below, or further steps may be added. Additionally, or alternatively, while two APs 102 and two STAs 104 are shown in the signaling diagram 400, more devices may be possible and the examples shown should not be construed as limiting.

The first AP 102-a and the second AP 102-b may be associated with a first BSS and a second BSS, respectively, where each BSS includes one or more STAs 104. For example, the first BSS may include one or more devices within a first coverage area 108 (such as the AP 102-a, the STA 104-a, the STA 104-b, and one or more other STAs 104). Similarly, the second BSS may include one or more devices within a second coverage area 108 (such as the AP 102-b, the STA 104-a, the STA 104-b, and one or more other STAs 104). The STAs 104 may be connected to the first AP 102-a, the second AP 102-b, or both via a communication link 106. In some examples, the first BSS and the second BSS may be overlapping to form an OBSS. For example, the STA 104-a and the STA 104-b may be included in both the first BSS and the second BSS, and may therefore be part of an OBSS associated with the first AP 102-a and the second AP 102-b. In some examples, the first AP 102-a may be a sharing AP and the second AP 102-b may be a shared AP, as discussed with reference to FIG. 1. In some other examples, the first AP 102-a may be a Coordinating AP and the second AP 102-b may be a Coordinated AP, as discussed with reference to FIG. 1.

The devices in the signaling diagram 400 may support a sequential channel sounding sequence for eMLSR STAs 104, STAs 104 in a CoEx mode, STAs 104 in a DPS mode, and other STAs 104 that may not be immediately available for frame exchanges with one or more APs 102. The techniques described herein also may extend to joint channel sounding. For a generic framework that supports each implementation (such as eMLSR STAs 104, CoEx STAs 104, DPS STAs 104, and other STAs 104), an exchange of an ICF 402 and an ICR 404 may occur at the beginning (such as before transmission of one or more NDPAs) of the sounding sequence for each BSS to 1.) enable a link for active operation for eMLSR STAs 104, 2.) solicit future unavailability information for a CoEx STA 104, and 3.) upgrade or transition a DPS STA 104 to full capability. Although described with reference to a sequential sounding sequence, it is understood that the techniques herein may be applied to any coordinated transmission messaging sequence between two or more APs 102, two or more STAs 104, or any combination thereof (such as any coordinated AP procedure).

In some implementations, the first AP 102-a and the second AP 102-b may collect CSI 408 from each BSS in the OBSS. For example, the first AP 102-a may collect 1.) CSI 408-a associated with a first channel (which may be referred to as a channel link) between the first STA 104-a and the first AP 102-a, and 2.) CSI 408-b associated with a second channel between the first STA 104-a and the second AP 102-b. Similarly, the second AP 102-b may collect 1.) CSI 408-c associated with a third channel between the second STA 104-b and the second AP 102-b, and 2.) CSI 408-d associated with a fourth channel between the second STA 104-b and the first AP 102-a.

The first AP 102-a may transmit, to the first STA 104-a, an ICF 402-a that prepares the STA 104-a to receive an NDPA, an NDP 406, and other CoBF channel sounding sequence frames (such as instructing the STA 104-a to transition from a first operating state to a second operating state). Based on the ICF 402-a, the first STA 104-a may transition to the second operating state (such as an active eMLSR link, an available CoEx mode, a full capability DPS mode) and transmit, to the first AP 102-a, an ICR 404-a acknowledging the ICF 402-a and indicating preparedness to exchange CoBF channel sounding frames.

Based on the ICF 402-a and the ICR 404-a, the first AP 102-a may perform a CoBF channel sounding sequence. For example, the AP 102-a may transmit an NDPA to announce to the client (such as the first STA 104-a) that the AP 102-a will send an NDP 406-a that the client is to use to estimate the channel response. The first AP 102-a may subsequently transmit the NDP 406-a and a BFRP to pull the CSI 408-a from the client. The CSI 408-a may describe a first channel between the first STA 104-a and the first AP 102-a. After the first CSI 408-a transmission by the first STA 104-a, the first AP 102-a may transmit a second NDPA to the first STA 104-a on behalf of the second AP 102-b (such as the channel sounding sequence may be transparent to the client, such that the first STA 104-a does not know that a second CSI 408-b will be with respect to an AP 102 that is not the AP 102 associated with the first STA 104-a). For example, the second NDPA frame may indicate, to the first STA 104-a, that the second AP 102-b is to transmit an NDP 406-b frame that the first STA 104-a is to use to estimate a second channel between the first STA 104-a and the second AP 102-b. After a second BFRP frame from the first AP 102-a, the first STA 104-a may transmit the second CSI 408-b.

The second half of the measurement phase may mirror the first half of the measurement phase, but performed by the second AP 102-b (such as an OBSS AP) and the second STA 104-b associated with the second BSS. For example, the second AP 102-b may transmit, to the second STA 104-b, a second ICF 402-b instructing the STA 104-b to transition from a first operating state to a second operating state in preparation for the channel sounding sequence (such as or requesting unavailability information, or both). The second STA 104-b may transition to the second operating state and may respond with a second ICR 404-b that acknowledges the ICF 402-b, indicates that the STA 104-b is in the second operating state, provides unavailability information (such as if the STA 104-b is a CoEx STA 104), or a combination thereof. The second AP 102-b may transmit a third NDPA, followed by transmission of a third NDP 406-c. After receiving a third BFRP, the second STA 104-b may transmit, to the second AP 102-b, third CSI 408-c associated with a third channel between the second AP 102-b and the second STA 104-b. The second AP 102-b may transmit a fourth NDPA to the second STA 104-b. The first AP 102-a may transmit, to the second STA 104-b, a fourth NDP 406-d that the second STA 104-b is to use to estimate a fourth channel between the first AP 102-a and the second STA 104-b. After receiving a fourth BFRP from the second AP 102-b, the second STA 104-b may transmit fourth CSI 408-d associated with the fourth channel between the first AP 102-a and the second STA 104-b.

Each frame in the signaling diagram 400 (and in other signaling diagrams described herein) may be separated in time from neighboring frames by a short interframe space (SIFS) (such as a delay in microseconds). However, the sounding sequence for the first BSS and the second BSS may be separated into a first TXOP (corresponding to the first half of the measurement phase) and a second TXOP (corresponding to the second half of the measurement phase) without any constraints on time separation between the CSI 408-b and the ICF 402-b.

In some other wireless communications systems, the second STA 104-b, which may support NPCA, may switch from a primary channel to a secondary primary channel (such as from the M-Primary channel to the O-Primary channel or the NPCA Primary channel as described with reference to FIG. 3) based on detecting OBSS transmissions during the exchange of the ICF 402-a, the ICR 404-a and the NDPA in the first BSS. In some examples, the second STA 104-b may monitor the secondary primary channel until the end of the first TXOP, and the second STA 104-b may not switch back to the primary channel before the second AP 102-b transmits the ICF 402-b, resulting in the second half of the measurement phase failing. That is, the second STA 104-b may not receive the ICF 402-b, transmit the ICR 404-b, or participate in any of the frame exchanges (such as NDPA, NDP 406-b, BFRP, CSI 408-c) in the second half of the measurement phase because the second STA 104-b switched to the secondary primary channel based on detecting the OBSS transmissions in the first half of the measurement phase.

In accordance with the techniques described herein, the second STA 104-b may not switch to a secondary primary channel during a coordinated transmission messaging sequence, such as a CoBF operation. For example, the first AP 102-a may transmit, to at least the first STA 104-a and to the second STA 104-b via a first primary channel, a first frame associated with the coordinated transmission messaging sequence by the first AP 102-a and the second AP 102-b. The first frame may indicate one or more parameters associated with a determination of whether to transition from the first primary channel to the secondary primary channel. In some examples, the first AP 102-a may communicate one or more subsequent frames associated with the coordinated transmission messaging sequence on the first primary channel in accordance with the one or more parameters.

In a first example, a parameter of the one or more parameters may indicate a first bandwidth associated with the coordinated transmission messaging sequence that spans the first primary channel and the second primary channel. The one or more subsequent frames may be communicated via the first bandwidth or via a second bandwidth that differs from the first bandwidth. For example, coordinated transmission messaging sequences may be enabled when the expected frames to be exchanged during the coordinated AP procedure span the entire available bandwidth of a respective BSS. For example, each of the ICF 402-a, ICR 404-a, first NDPA, NDP 406-a, BFRP, CSI 408-a, second NDPA, second BFRP, and CSI 408-b may span the full bandwidth of the first BSS, which may match the bandwidth of the second BSS. That is, the one or more subsequent frames may span an entirety of the first primary channel and the secondary primary channel.

In some examples, the AP 102-a may indicate, via a first parameter of the one or more parameters in the ICF 402-a, that the frames sent within the first TXOP will span the bandwidth of the first BSS. Based on receiving the indication in the ICF 402-a, the second STA 104-b may determine that the secondary primary channel will be busy (or occupied), and may not switch to the secondary primary channel. That is, the second STA 104-b may remain on the first primary channel and may be able to detect and receive the ICF 402-b to perform the second half of the measurement phase. Additionally, or alternatively, the first AP 102-a may indicate, via the first parameter in the ICF 402-a, a pseudo-full bandwidth operation. That is, the ICF 402-a may indicate in the first parameter that the frames transmitted in the first TXOP will span the entire bandwidth of the first BSS, but the first AP 102-a may transmit and receive frames via the second bandwidth, which may be less than the first bandwidth (the second STA 104-b may interpret the frames as spanning the entire bandwidth and thus may not switch to the secondary primary channel). For example, the first AP 102-a may transmit subsequent frames within the bandwidth of the first primary channel, or another bandwidth that is smaller than an entirety of the operating bandwidth, even though the ICF 402-a indicated that the first AP 102-a is using the entirety of operating bandwidth (such as operating bandwidth 335 of FIG. 3).

In a second example, a parameter of the one or more parameters may indicate a first duration for providing network allocation vector (NAV) 410 protection, and the first duration may be less than a channel switching threshold duration corresponding to transition between the first primary channel and the secondary primary channel. NAV protection 410 may set the duration value of a frame to cover the duration of the response frame and two SIFS to silence other STAs 104 that may attempt to access the medium before the duration of the NAV protection 410 expires. For example, the first AP 102-a may receive a second frame on the first primary channel based at least in part on the first frame, and the duration of the NAV protection 410 may be equal to a duration of the first frame, a duration of the second frame, and a duration of two SIFS, where a first SIFS of the two SIFS is subsequent to the first frame and a second SIFS of the two SIFS is subsequent to the second frame. That is, the NAV protection 410 duration may span from the ICF 402-a to the beginning of the first NDPA (such as the NAV protection 410 duration may include the duration for the ICF 402-a, a first SIFS duration after the ICF 402-a, the duration for the ICR 404-a, and its corresponding SIFS duration).

Additionally, or alternatively, a parameter in the second frame may indicate a second duration for providing NAV protection 410, and the second duration may be less than a channel switching threshold duration corresponding to transition between the first primary channel and the secondary primary channel. For example, the second duration of the NAV protection 410 may be equal to a duration of the second frame and a duration of an SIFS, where the SIFS is subsequent to the second frame. That is, the NAV protection 410 duration may span from the ICR 404-a to the beginning of the first NDPA (such as the NAV protection 410 duration may include the duration for the ICR 404-a and its corresponding SIFS duration).

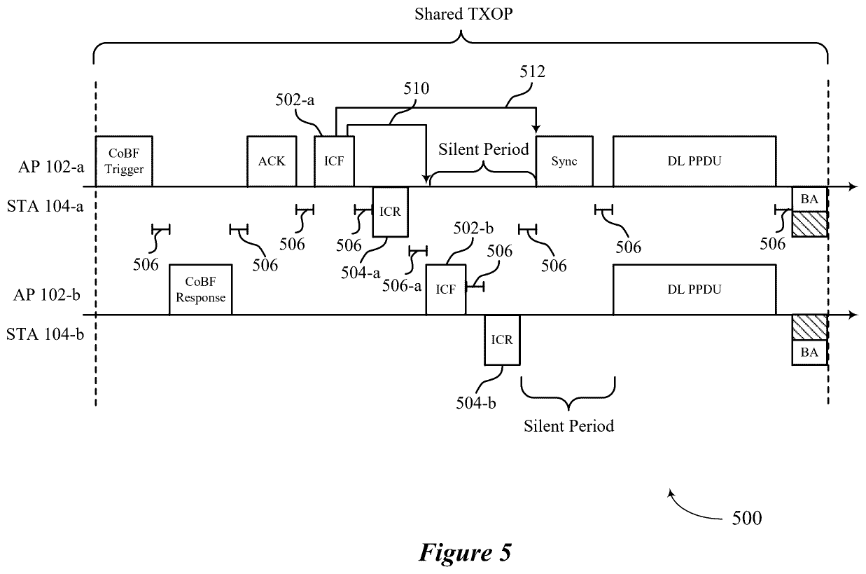

Based on using NAV protection 410 in ICFs 402, ICRs 404, or both, the duration of the OBSS TXOP on the first primary channel may be shorter than the channel switching threshold duration, and the second STA 104-b may not switch to the secondary primary channel. That is, based on detecting the ICFs 402 or the ICRs 404 with NAV protection 410, the second STA 104-b may determine that the OBSS transmissions will occupy the first primary channel for a relatively short duration (such as less than the channel switching threshold duration), and may not switch to the secondary primary channel. In some examples, as described further with reference to FIG. 5, other STAs 104 (such as other than the first STA 104-a) may attempt to transmit their frames after expiration of the NAV protection 410 duration, which may interrupt the coordinated transmission messaging sequence. In a third example, a parameter of the one or more parameters may indicate, in the ICF 402-a, a second duration for providing NAV protection 410 in the ICF 402-b. The second duration may include any silent periods that occur during the coordinated transmission messaging sequence. That is, the first AP 102-a may perform, based on transmission of the first frame and the one or more subsequent frames, the coordinated transmission messaging sequence with the second AP 102-b, and the coordinated transmission messaging sequence may include one or more silent periods between communication of respective frames. In some examples, the first AP 102-a may select the second duration to cover a longest possible silent period in all coordinated transmission messaging sequences.

Additionally, or alternatively, the first AP 102-a, the second AP 102-b, or both, may select the channel switching threshold duration such that the second duration indicated in the ICF 402-a is below the channel switching threshold duration. The channel switching threshold duration may correspond to a value used by a STA 104 to decide whether to switch to the secondary primary channel or not. If the second duration is less than the channel switching duration, the STA 104 may not switch. Otherwise, the STA 104 may switch to the secondary primary channel. In some examples, the second STA 104-b may receive an indication of the channel switching threshold duration from the second AP 102-b. Based on receiving the ICF 402-a that indicates the second duration, the second STA 104-b may not switch to the secondary primary channel while a coordinated transmission messaging sequence is occurring (such as ongoing or initiated by the first AP 102-a) while also ensuring that no other STAs 104 will attempt to access the medium during silent periods following ICF/ICR exchanges.

In the example of the signaling diagram 400, the second duration indicated in the ICF 402-a may cover until the beginning of the next frame transmitted by the first AP 102-a, which may be the NDPA frame. The second duration may cover until the next transmitted frame because other STAs 104, such as the second STA 104-b, may not detect a response frame transmitted by a device other than the first AP 102-a (such as the ICR 404-a or NDP 406-b). Additionally, or alternatively, the NAV protection 410 duration may last until the ICF 402-b. The risk of other in-BSS clients jumping on the medium may be reduced in the signaling diagram 400 because there may be no silent periods between the ICR 404-a and the NDPA frames. However, the concept is similar where the second duration is selected by the first AP 102-a to be long enough to provide NAV protection 410 against in-BSS transmissions, but not longer than the channel switching duration threshold. Although described with reference to the signaling diagram 400, it is understood that the first AP 102-a may set the NAV protection 410 duration for any frame to last until a next frame to be transmitted by the first AP 102-a.

In some examples, if the NAV protection 410 indicated in the ICF 402-a is greater than the channel switching duration threshold, the second AP 102-b may not switch to the secondary primary channel because the second AP 102-b may infer the ICF 402-a as the beginning of a CoBF sounding sequence. Based on not switching to the secondary primary channel, the second AP 102-b may not respond to the second STA 104-b if the second STA 104-b switched to the secondary primary channel. Based on the second AP 102-b not responding to transmissions from the second STA 104-b, the second STA 104-b may switch back to the first primary channel before the second AP 102-b transmits the ICF 402-b.

In a fourth example, a parameter of the one or more parameters may indicate that a NPCA operation may be disallowed or disabled during the coordinated transmission messaging sequence by the first AP 102-a and the second AP 102-b (such as a CoBF frame exchange sequence). The NPCA operation may be associated with transition between the first primary channel and the secondary primary channel. In some examples, NPCA operation may be disallowed or disabled for one or more STAs 104 based on an indication that the NPCA operation is enabled at the one or more STAs. That is, the NPCA operation may be disallowed or disabled for NPCA-enabled clients (such as the second STA 104-b). In some other examples, NPCA operation may be disallowed or disabled for the first AP 102-a with respect to the second AP 102-b but may be allowed or enabled with respect to at least a third AP 102. That is, NPCA operation may be disallowed or disabled with respect to a set of OBSSs. For example, the second STA 104-b may not be allowed to perform NPCA operation if it detects OBSS transmissions from the first AP 102-a or from the second AP 102-b. However, the second STA 104-b may perform NPCA operation if it detects OBSS transmissions from a third AP 102.

The first AP 102-a may announce, via the first frame, when NPCA operation is disallowed or disabled if the AP 102-a expects to perform a coordinated transmission messaging procedure with the second AP 102-b. In some examples, the first AP 102-a may transmit, to the first STA 104-a via the first primary channel, a second frame indicating that the NPCA operation is allowed or enabled based on completion of the coordinated transmission messaging sequence. In some examples, the first frame may be a first beacon frame and the second frame may be a next beacon frame subsequent to the first beacon frame. The first AP 102-a may indicate that the NPCA operation is disallowed or disabled based on at least a portion of the coordinated transmission messaging sequence occurring in an interval between the first frame and the second frame. That is, the AP 102 may announce whether NPCA switching is allowed or enabled on a beacon-interval basis (for each beacon interval). In some other examples, the first frame may be a first management frame and the second frame may be a second management frame, and the first AP 102-a may indicate that the NPCA operation is disallowed or disabled based on at least a portion of the coordinated transmission messaging sequence occurring in an interval between the first frame and the second frame. That is, the first AP 102-a may announce the allowance or disallowance of NPCA in the first BSS using management frames (such as action frames).

Additionally, or alternatively, the first AP 102-a may indicate one or more service periods (SPs) beginning at a first time and ending at a second time, and the indication that the NPCA operation is disallowed or disabled may be based on the coordinated transmission messaging sequence occurring within the one or more SPs. In some examples, the first AP 102-a may transmit target wake time (TWT)-based signaling to indicate the one or more SPs with coordinated transmission signaling sequences. That is, the first AP 102-a may indicate the one or more SPs using any signaling that may define the one or more SPs with one or more characteristics, parameters, or attributes (such as NPCA operation is disallowed or disabled during the one or more SPs). For example, the first AP 102-a may transmit one or more coordinated restricted TWT (C-rTWT) SPs.

In some examples, the first AP 102-a may disallow or disable NPCA operation during the coordinated transmission messaging sequence based on a set of one or more conditions being satisfied. For example, the first AP 102-a may indicate that NPCA operation is disallowed or disabled based on a specific coordinated transmission messaging sequence being enabled, such as a coordinated beamforming channel sounding sequence, a coordinated beamforming data transmission sequence, a coordinated spatial reuse sequence, or a coordinated beamforming time division multiple access sequence. Additionally, or alternatively, the first AP 102-a may disallow or disable NPCA operation based on setting the one or more parameters such that the second STA 104-b may determine not to switch to the secondary primary channel. For example, the first AP 102-a may indicate a NAV protection 410 shorter than the channel switching threshold duration such that the second STA 104-b does not switch to the secondary primary channel prior to receiving the ICF 402-b. In another example, the first AP 102-a may indicate that NPCA operation is disallowed or disabled using a parameter or field in a transmitted frame (such as in the ICF 402-a). In a third example, the first AP 102-a may indicate a set of APs 102 in which the second STA 104-b is allowed, or not allowed, to perform NPCA operation. In accordance with any of the examples described herein, the second STA 104-b may avoid switching to the secondary primary channel during a coordinated transmission messaging sequence, which may result in fewer failed coordinated transmission messaging sequences.

Although the signaling diagram 400 illustrates an example in which NPCA operation is disallowed (e.g., disabled) by the APs 102 such as the AP 102-a, it may be understood that the techniques described herein may apply to an example in which NPCA operation is disallowed by one or more of the STAs 104.

FIG. 5 shows an example of a signaling diagram 500 that supports NPCA conditions for joint operation with coordinated AP procedures. In some examples, the signaling diagram 500 may implement aspects of the wireless communications network 100, the signaling diagram 200, and the time-frequency diagram 300. For example, the signaling diagram 500 includes a first AP 102-a, a second AP 102-b, a first STA 104-a, a second STA 104-b, which may be examples of the corresponding devices described with reference to FIG. 1. In some examples, steps in the signaling diagram 500 may include additional features not mentioned below, or further steps may be added.

Additionally, or alternatively, while two APs 102 and two STAs 104 are shown in the signaling diagram 500, more devices may be possible and the examples shown should not be construed as limiting. The wireless devices illustrated by the signaling diagram 500 may be part of an OBSS, including a first BSS associated with the first AP 102-a and a second BSS associated with the second AP 102-b.

Although the signaling diagram 500 illustrates an example transmission scheme in which the ICF/ICR exchanges are time staggered across the two BSSs, it may be understood that the techniques described herein may apply to ICF/ICR exchanges that are transmitted concurrently by the first AP 102-a and the second AP 102-b. Additionally, while described with reference to an example transmissions scheme, it is understood that the techniques herein may be applied to any coordinated transmission messaging sequence between two or more APs 102, two or more STAs 104, or any combination thereof (such as any coordinated AP procedure).

In some examples, staggering the ICF/ICR exchanges may result in silent periods between each AP 102 and one or more associated scheduled STAs 104. It may be understood that a silent period may refer to any period in which the first STA 104-a or the second STA 104-b do not transmit or receive any frames, and does not exclude other STAs 104 or APs 102 (not illustrated) from transmitting on the first primary channel or a secondary primary channel during a respective silent period. That is, the silent periods illustrated in the signaling diagram 500 may be silent with respect to first STA 104-a and the second STA 104-b.

Note that an ACK/Sync frame (such as described with reference to FIG. 2) may be split into two or more frames: 1.) an ACK frame sent before sending the ICF/ICR (such as between the CoBF response and the ICF 502-a), and 2.) a sync frame sent right before the downlink PPDUs (such as between the ICR 504-b and the downlink PPDU).

As part of the staggered ICF/ICR exchange, the first AP 102-a may transmit an ICF 502-a to the first STA 104-a in a first time occasion, during which the second AP 102-b is silent. The first STA 104-a may transmit an ICR 504-a to the first AP 102-a. During a second time occasion (such as while the first AP 102-a is silent), the second AP 102-b may transmit an ICF 502-b to the second STA 104-b. Finally, the second STA 104-b may transmit an ICR 504-b to the second AP 102-b. Each frame of the signaling diagram 500 may be separated from one or more other frames (such as neighboring frames, or frames immediately preceding or immediately following each frame) by one or more SIFS 506. For example, the SIFS 506-a may separate the ICR 504-b from the Sync frame in time.

In some other wireless communications systems, the second STA 104-b, which may support NPCA, may switch from a first primary channel to a secondary primary channel (such as from the M-Primary channel to the O-Primary channel or the NPCA Primary channel as described with reference to FIG. 3) based on detecting OBSS transmissions during the exchange of the ICF 502-a and the ICR 504-a in the first BSS. In some examples, the second STA 104-b may monitor the secondary primary channel until the end of the TXOP, and the second STA 104-b may not switch back to the primary channel before the second AP 102-b transmits the ICF 502-b, resulting in the DL PPDU/BA transmission failing. That is, the second STA 104-b may not receive the ICF 502-b, transmit the ICR 504-b, or participate in any of the frame exchanges (such as DL PPDU or BA) in the remainder of the TXOP because the second STA 104-b switched to the secondary primary channel based on detecting the ICF/ICR exchange in the first BSS.

In accordance with the techniques described herein, the second STA 104-b may not switch to a secondary primary channel during a coordinated transmission messaging sequence, such as a CoBF operation. For example, the first AP 102-a may transmit, to at least the first STA 104-a and to the second STA 104-b via a first primary channel, a first frame associated with the coordinated transmission messaging sequence by the first AP 102-a and the second AP 102-b. The first frame may indicate one or more parameters associated with a determination of whether to transition from the first primary channel to the secondary primary channel. In some examples, the first AP 102-a may communicate one or more subsequent frames associated with the coordinated transmission messaging sequence on the first primary channel in accordance with the one or more parameters.

In a first example, a parameter of the one or more parameters may indicate a first bandwidth associated with the coordinated transmission messaging sequence that spans the first primary channel and the second primary channel. The one or more subsequent frames may be communicated via the first bandwidth or via a second bandwidth that differs from the first bandwidth. For example, coordinated transmission messaging sequences may be enabled when the expected frames to be exchanged during the coordinated AP procedure span the entire available bandwidth of a respective BSS (such as an entirety of operating bandwidth 335 of FIG. 3). For example, each of the ICF 502-a, ICR 504-a, Sync frame, DL PPDU, and BA may span the full bandwidth of the first BSS, which may match the bandwidth of the second BSS. That is, the one or more subsequent frames may span an entirety of the first primary channel and the secondary primary channel.

In some examples, the AP 102-a may indicate, via the parameter in the ICF 502-a, that the frames sent within the TXOP will span the bandwidth of the first BSS. Based on receiving the indication in the ICF 502-a, the second STA 104-b may determine that the secondary primary channel will be busy (or occupied), and may not switch to the secondary primary channel. That is, the second STA 104-b may remain on the first primary channel and may be able to detect and receive the ICF 502-b to perform the coordinated transmission messaging sequence. Additionally, or alternatively, the first AP 102-a may indicate, via the first parameter in the ICF 502-a, a pseudo-full bandwidth operation. That is, the ICF 502-a may indicate in the first parameter that the frames transmitted in the TXOP will span the entire bandwidth of the first BSS, but the first AP 102-a may transmit and receive frames via the second bandwidth, which may be less than the first bandwidth (the second STA 104-b may interpret the frames as spanning the entire bandwidth and thus may not switch to the secondary primary channel). For example, the first AP 102-a may transmit subsequent frames within the bandwidth of the first primary channel, or another bandwidth that is smaller than an entirety of the operating bandwidth, even though the ICF 402-a indicated that the first AP 102-a is using the entirety of operating bandwidth (such as operating bandwidth 335 of FIG. 3).

In a second example, a parameter of the one or more parameters may indicate a first duration for providing NAV protection 510, and the first duration may be less than a channel switching threshold duration corresponding to transition between the first primary channel and the secondary primary channel. NAV protection 510 may set the duration value of a frame to cover the duration of the response frame and two SIFS to ensure silencing other STAs 104 that may attempt to access the medium. For example, the first AP 102-a may receive a second frame on the first primary channel based at least in part on the first frame, and the duration of the NAV protection 510 may be equal to a duration of the first frame, a duration of the second frame, and a duration of two SIFS, where a first SIFS of the two SIFS is subsequent to the first frame and a second SIFS of the two SIFS is subsequent to the second frame. That is, the NAV protection 510 duration may span from the ICF 502-a to the beginning of a first silent period (such as the NAV protection 510 duration may include the duration for the ICF 502-a, a first SIFS duration after the ICF 502-a, the duration for the ICR 504-a, and its corresponding SIFS duration).

Additionally, or alternatively, a parameter in the second frame may indicate a second duration for providing NAV protection 510, and the second duration may be less than a channel switching threshold duration corresponding to transition between the first primary channel and the secondary primary channel. For example, the second duration of the NAV protection 510 may be equal to a duration of the second frame and a duration of an SIFS, where the SIFS is subsequent to the second frame. That is, the NAV protection 510 duration may span from the ICR 504-a to the beginning of the first NDPA (such as the NAV protection 510 duration may include the duration for the ICR 504-a and its corresponding SIFS duration).

Based on using NAV protection 510 in ICFs 502, ICRs 504, or both, the duration of the OBSS TXOP on the first primary channel may be shorter than the channel switching threshold duration, and the second STA 104-b may not switch to the secondary primary channel. That is, based on detecting the ICFs 502 or the ICRs 504 with NAV protection 510, the second STA 104-b may determine that the OBSS transmissions will occupy the first primary channel for a relatively short duration (such as less than the channel switching threshold duration), and may not switch to the secondary primary channel. In some examples, however, other STAs 104 (such as other than the first STA 104-a) may attempt to transmit their frames during the first silent period that occurs after expiration of the NAV protection 510 duration, which may interrupt the coordinated transmission messaging sequence. That is, other STAs 104 not involved in the coordinated transmission messaging sequence may jump on the medium within the first silent period.

In a third example, a parameter of the one or more parameters may indicate, in the ICF 402-a, a second duration for providing NAV protection 512 in the ICF 402-b. The second duration may include any silent periods that occur during the coordinated transmission messaging sequence. That is, the first AP 102-a may perform, based on transmission of the first frame and the one or more subsequent frames, the coordinated transmission messaging sequence with the second AP 102-b, and the coordinated transmission messaging sequence may include one or more silent periods between communication of respective frames (such as the first silent period and the second silent period). In some examples, the first AP 102-a may select the second duration to cover a longest possible silent period in all coordinated transmission messaging sequences.

Additionally, or alternatively, the first AP 102-a, the second AP 102-b, or both, may select the channel switching threshold duration such that the second duration indicated in the ICF 402-a is below the channel switching threshold duration. The channel switching threshold duration may correspond to a value used by a STA 104 to decide whether to switch to the secondary primary channel or not. If the second duration is less than the channel switching threshold duration, the STA 104 may not switch. Otherwise, the STA 104 may switch to the secondary primary channel. In some examples, the second STA 104-b may receive an indication of the channel switching threshold duration from the second AP 102-b. Based on receiving the ICF 402-a that indicates the second duration of the NAV protection 512, the second STA 104-b may not switch to the secondary primary channel while a coordinated transmission messaging sequence is occurring (such as ongoing or initiated by the first AP 102-a) while also ensuring that no other STAs 104 will attempt to access the medium during silent periods following ICF/ICR exchanges.

In the example of the signaling diagram 500, the second duration indicated in the ICF 502-a may cover until the beginning of the next frame transmitted by the first AP 102-a, which may be the Sync frame. The second duration may cover until the next transmitted frame because other STAs 104, such as the second STA 104-b, may not detect a response frame transmitted by a device other than the first AP 102-a (such as the ICR 504-a). The NAV protection 512 may prevent other in-BSS clients jumping on the medium during silent periods that occur after ICF/ICR exchanges. Although described with reference to the signaling diagram 500, it is understood that the first AP 102-a may set the NAV protection 512 duration for any frame to last until a next frame to be transmitted by the first AP 102-a.

In a fourth example, a parameter of the one or more parameters may indicate that a NPCA operation may be disallowed or disabled during the coordinated transmission messaging sequence by the first AP 102-a and the second AP 102-b (such as a CoBF frame exchange sequence). The NPCA operation may be associated with transition between the first primary channel and the secondary primary channel. In some examples, NPCA operation may be disallowed or disabled for one or more STAs 104 based on an indication that the NPCA operation is enabled at the one or more STAs. That is, the NPCA operation may be disallowed or disabled for NPCA-enabled clients (such as the second STA 104-b). In some other examples, NPCA operation may be disallowed or disabled for the first AP 102-a with respect to the second AP 102-b but may be allowed or enabled with respect to at least a third AP 102. That is, NPCA operation may be disallowed or disabled with respect to a set of OBSSs. For example, the second STA 104-b may not be allowed to perform NPCA operation if it detects OBSS transmissions from the first AP 102-a or from the second AP 102-b. However, the second STA 104-b may perform NPCA operation if it detects OBSS transmissions from a third AP 102.

The first AP 102-a may announce, via the first frame, when NPCA operation is disallowed or disabled if the AP 102-a expects to perform a coordinated transmission messaging procedure with the second AP 102-b. In some examples, the first AP 102-a may transmit, to the first STA 104-a via the first primary channel, a second frame indicating that the NPCA operation is allowed or enabled based on completion of the coordinated transmission messaging sequence. In some examples, the first frame may be a first beacon frame and the second frame may be a next beacon frame subsequent to the first beacon frame. The first AP 102-a may indicate that the NPCA operation is disallowed or disabled based on at least a portion of the coordinated transmission messaging sequence occurring in an interval between the first frame and the second frame. That is, the AP 102 may announce whether NPCA switching is allowed or enabled on a beacon-interval basis (for each beacon interval). In some other examples, the first frame may be a first management frame and the second frame may be a second management frame, and the first AP 102-a may indicate that the NPCA operation is disallowed or disabled based on at least a portion of the coordinated transmission messaging sequence occurring in an interval between the first frame and the second frame. That is, the first AP 102-a may announce the allowance or disallowance of NPCA in the first BSS using management frames (such as action frames).

Additionally, or alternatively, the first AP 102-a may indicate one or more SPs beginning at a first time and ending at a second time, and the indication that the NPCA operation is disallowed or disabled may be based on the coordinated transmission messaging sequence occurring within the one or more SPs. In some examples, the first AP 102-a may transmit TWT-based signaling to indicate the one or more SPs with coordinated transmission signaling sequences. That is, the first AP 102-a may indicate the one or more SPs using any signaling that may define the one or more SPs with one or more characteristics, parameters, or attributes (such as NPCA operation is disallowed during the one or more SPs). For example, the first AP 102-a may transmit one or more C-rTWT SPs.

In some examples, the first AP 102-a may disallow or disable NPCA operation during the coordinated transmission messaging sequence based on a set of one or more conditions being satisfied. For example, the first AP 102-a may indicate that NPCA operation is disallowed or disabled based on a specific coordinated transmission messaging sequence being enabled, such as a coordinated beamforming channel sounding sequence, a coordinated beamforming data transmission sequence, a coordinated spatial reuse sequence, or a coordinated beamforming time division multiple access sequence. Additionally, or alternatively, the first AP 102-a may disallow or disable NCPCA operation based on setting the one or more parameters such that the second STA 104-b may determine not to switch to the secondary primary channel. For example, the first AP 102-a may indicate a NAV protection 512 shorter than the channel switching threshold duration such that the second STA 104-b does not switch to the secondary primary channel prior to receiving the ICF 502-b. In another example, the first AP 102-a may indicate that NPCA operation is disallowed or disabled using a parameter or field in a transmitted frame (such as in the ICF 402-a). In a third example, the first AP 102-a may indicate a set of APs 102 in which the second STA 104-b is allowed, or not allowed, to perform NPCA operation.

Although the signaling diagram 500 illustrates an example in which NPCA operation is disallowed disabled by the APs 102 such as the first AP 102-a, it may be understood that the techniques described herein may apply to an example in which NPCA operation is disallowed or disabled by one or more of the STAs 104.

In a fifth example, an NPCA-enabled STA 104, such as the second STA 104-b, may delay its decision to switch to the secondary primary channel until the NPCA-enabled STA 104 receives a third OBSS PPDU (the second PPDU after the first detected OBSS PPDU), as part of coordinated transmission messaging sequence. For example, the second STA 104-b may not switch to the secondary primary channel until reception of the ICF 502-b. Based on receiving the third PPDU, the second STA 104-b may begin processing the third PPDU. In some examples, the second STA 104-b may decode at least a first field of the third PPDU and determine whether to switch to the secondary primary channel based on decoding at least the first field. For example, the coordinated transmission messaging sequence may be an OBSS transmission sequence that includes ICF transmission, followed by ICR transmission, followed by transmission of the third PPDU.

In some examples, the first field of the third PPDU may be a HE-SIG-A field if the third PPDU is an HE-formatted PPDU, and the second STA 104-b may switch to the secondary primary channel. In some other examples, the first field of the third PPDU may be a U-SIG field if the third PPDU is an EHT-formatted PPDU. Based on being an HE-formatted PPDU or an EHT-formatted PPDU, the HE-SIG-A field or the U-SIG field may indicate a color of the BSS. That is, the first field may include an indication of which AP 102 transmitted the third PPDU. For example, the second STA 104-b may decode a first field of the PHY preamble in the third PPDU to determine whether the third PPDU is an in-BSS PPDU or an OBSS PPDU (whether the AP 102-b or the AP 102-a transmitted the third PPDU). The second STA 104-b may switch to the secondary primary channel if the third PPDU is an OBSS PPDU. That is, the STA 104-b may switch to the secondary primary channel if the first AP 102-a transmitted the third PPDU. Otherwise, such as if the third PPDU is an in-BSS PPDU transmitted by the second AP 102-b, or if it is not received after a threshold duration, the second STA 104-b may not switch.

In some other examples, the first field of the third PPDU may be a transmitter address (TA) field, receiver access (RA) field, or any combination thereof. The second AP 102-b may determine whether the third PPDU includes the HE-SIG-A field or the U-SIG field (such as if the third PPDU does not support HE or EHT formats). Additionally, or alternatively, second STA 104-b may decode the TA field, the RA field, or both, of the third PPDU to determine whether the third PPDU is an in-BSS transmission or an OBSS transmission if the BSS color field value in the HE-SIG-A field or in the U-SIG field is set to 0 or if the fields are not included in the frame. For example, the second STA 104-b may decode a MAC header in the third PPDU, and the MAC header may include the first field. The TA field, the RA field, or both, may indicate whether the third PPDU was transmitted by the second AP 102-b or another AP 102, such as the first AP 102-a. Based on whether the third PPDU is an in-BSS PPDU or an OBSS PPDU, the second STA 104-b may determine whether to switch to the O-Primary channel (e.g., the NPCA Primary channel). In some examples, the second STA 104-b may implement the fifth example for the CoBF transmission sequence (and not for the CoBF channel sounding sequence). In accordance with any of the examples described herein, the second STA 104-b may avoid switching to the secondary primary channel during a coordinated transmission messaging sequence, which may result in fewer failed coordinated transmission messaging sequences.

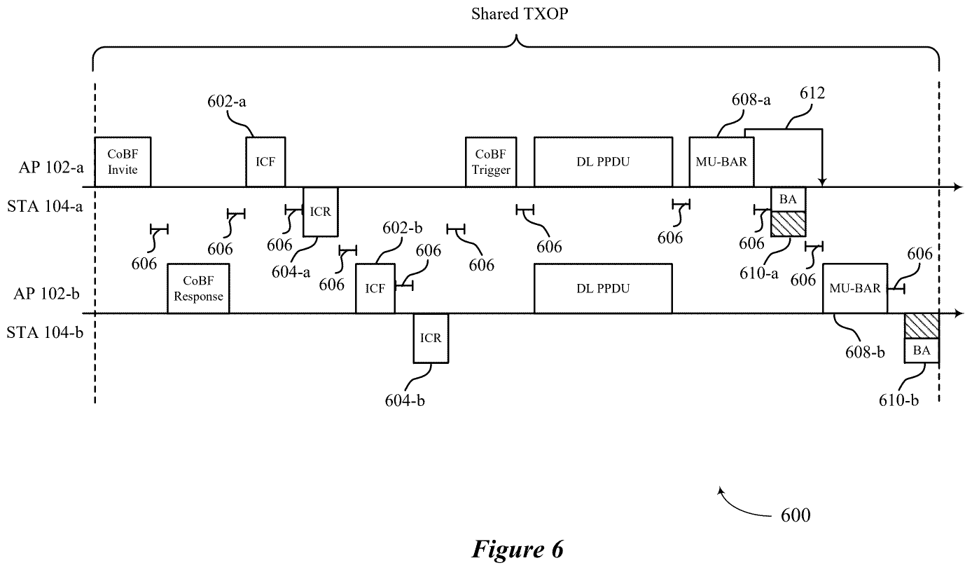

FIG. 6 shows an example of a signaling diagram 600 that supports NPCA conditions for joint operation with coordinated AP procedures. In some examples, the signaling diagram 600 may implement aspects of the wireless communications network 100, the signaling diagram 200, and the time-frequency diagram 300. For example, the signaling diagram 600 includes a first AP 102-a, a second AP 102-b, a first STA 104-a, a second STA 104-b, which may be examples of the corresponding devices described with reference to FIG. 1. In some examples, operations in the signaling diagram 600 may include additional features not mentioned below, or further operations may be added. Additionally, or alternatively, while two APs 102 and two STAs 104 are shown in the signaling diagram 600, more devices may be possible and the examples shown should not be construed as limiting. The wireless devices illustrated by the signaling diagram 600 may be part of an OBSS, including a first BSS associated with the first AP 102-a and a second BSS associated with the second AP 102-b.

Although the signaling diagram 600 illustrates an example transmission scheme in which the ICF/ICR exchanges are time staggered across the two BSSs, it may be understood that the techniques described herein may apply to ICF/ICR exchanges that are transmitted concurrently by the first AP 102-a and the second AP 102-b. Additionally, while described with reference to an example transmissions scheme, it is understood that the techniques herein may be applied to any coordinated transmission messaging sequence between two or more APs 102, two or more STAs 104, or any combination thereof (such as any coordinated AP procedure).

As part of the staggered ICF/ICR exchange, the first AP 102-a may transmit an ICF 602-a to the first STA 104-a in a first time occasion, during which the second AP 102-b is silent. The first STA 104-a may transmit an ICR 604-a to the first AP 102-a. During a second time occasion (such as while the first AP 102-a is silent), the second AP 102-b may transmit an ICF 602-b to the second STA 104-b. Finally, the second STA 104-b may transmit an ICR 604-b to the second AP 102-b. Each frame of the signaling diagram 600 may be separated from one or more other frames (such as neighboring frames, or frames immediately preceding or immediately following each frame) by one or more SIFS 606.

In some other wireless communications systems, the second STA 104-b, which may support NPCA, may switch from a first primary channel to a secondary primary channel (such as from the M-Primary channel to the O-Primary channel or the NPCA Primary channel as described with reference to FIG. 3) based on detecting OBSS transmissions during the exchange of the ICF 602-a and the ICR 604-a in the first BSS. In some examples, the second STA 104-b may monitor the secondary primary channel until the end of the TXOP, and the second STA 104-b may not switch back to the primary channel before the second AP 102-b transmits the ICF 602-b, resulting in the DL PPDU/BA transmission failing. That is, the second STA 104-b may not receive the ICF 602-b, transmit the ICR 604-b, or participate in any of the frame exchanges (such as DL PPDU or BA) in the remainder of the TXOP because the second STA 104-b switched to the secondary primary channel based on detecting the ICF/ICR exchange in the first BSS.

In accordance with the techniques described herein, the second STA 104-b may not switch to a secondary primary channel during a coordinated transmission messaging sequence, such as a CoBF operation. For example, the first AP 102-a may transmit, to at least the first STA 104-a and to the second STA 104-b via a first primary channel, a first frame associated with the coordinated transmission messaging sequence by the first AP 102-a and the second AP 102-b. The first frame may indicate one or more parameters associated with a determination of whether to transition from the first primary channel to the secondary primary channel. In some examples, the first AP 102-a may communicate one or more subsequent frames associated with the coordinated transmission messaging sequence on the first primary channel in accordance with the one or more parameters.

In some implementations, the APs 102 may each transmit, to the STAs, a multi-user block acknowledgment request (MU-BAR) requesting a block acknowledgment (BA) response from the STAs. For example, the first AP 102-a may transmit a MU-BAR 608-a to the first STA 104-a. In response, the first STA 104-a may transmit, to the first AP 102-a, a BA 610-a confirming that the STA 104-a received a block of one or more frames from the first AP 102-a. In some other examples, the second AP 102-b may transmit a MU-BAR 608-b to the second STA 104-b. In response, the second STA 104-b may transmit, to the second AP 102-b, a BA 610-b confirming that the STA 104-b received a block of one or more frames from the second AP 102-b.

Although the signaling diagram 600 illustrates an example transmission scheme in which the MU-BAR/BA exchanges are time staggered across the two BSSs, it may be understood that the techniques described herein may apply to MU-BAR/BA exchanges that are transmitted concurrently by the first AP 102-a and the second AP 102-b. Additionally, while described with reference to an example transmissions scheme, it is understood that the techniques herein may be applied to any coordinated transmission messaging sequence between two or more APs 102, two or more STAs 104, or any combination thereof (such as any coordinated AP procedure).

As part of the staggered MU-BAR/BA exchange, the first AP 102-a may transmit the MU-BAR 608-a to the first STA 104-a in a first time occasion, during which the second AP 102-b is silent. The first STA 104-a may transmit the BA 610-a to the first AP 102-a. During a second time occasion (such as while the first AP 102-a is silent), the second AP 102-b may transmit the MU-BAR 608-b to the second STA 104-b. Finally, the second STA 104-b may transmit the BA 610-b to the second AP 102-b. Each frame of the signaling diagram 600 may be separated from one or more other frames (such as neighboring frames, or frames immediately preceding or immediately following each frame) by one or more SIFS 606.

In a first example, a parameter of the one or more parameters may indicate a first bandwidth associated with the coordinated transmission messaging sequence that spans the first primary channel and the second primary channel. The one or more subsequent frames may be communicated via the first bandwidth or via a second bandwidth that differs from the first bandwidth. For example, coordinated transmission messaging sequences may be enabled when the expected frames to be exchanged during the coordinated AP procedure span the entire available bandwidth of a respective BSS (such as an entirety of operating bandwidth 335 of FIG. 3). For example, each of the ICF 602-a, ICR 604-a, DL PPDU, MU-BAR 608-a, and BA 610-a may span the full bandwidth of the first BSS, which may match the bandwidth of the second BSS. That is, the one or more subsequent frames may span an entirety of the first primary channel and the secondary primary channel.

In some examples, the AP 102-a may indicate, via the parameter in the ICF 602-a, that the frames sent within the TXOP will span the bandwidth of the first BSS.

Based on receiving the indication in the ICF 602-a, the second STA 104-b may determine that the secondary primary channel will be busy (or occupied), and may not switch to the secondary primary channel. That is, the second STA 104-b may remain on the first primary channel and may be able to detect and receive the ICF 602-b to perform the coordinated transmission messaging sequence. Additionally, or alternatively, the first AP 102-a may indicate, via the first parameter in the ICF 602-a, a pseudo-full bandwidth operation. That is, the ICF 602-a may indicate in the first parameter that the frames transmitted in the TXOP will span the entire bandwidth of the first BSS, but the first AP 102-a may transmit and receive frames via the second bandwidth, which may be less than the first bandwidth (the second STA 104-b may interpret the frames as spanning the entire bandwidth and thus may not switch to the secondary primary channel). For example, the first AP 102-a may transmit subsequent frames within the bandwidth of the first primary channel, or another bandwidth that is smaller than an entirety of the operating bandwidth, even though the ICF 602-a indicated that the first AP 102-a is using the entirety of operating bandwidth (such as operating bandwidth 335 of FIG. 3).

In a second example, a parameter of the one or more parameters may indicate a first duration for providing NAV protection, and the first duration may be less than a channel switching threshold duration corresponding to transition between the first primary channel and the secondary primary channel. NAV protection may set the duration value of a frame to cover the duration of the response frame and two SIFS to ensure silencing other STAs 104 that may attempt to access the medium. For example, the first AP 102-a may receive a second frame on the first primary channel based at least in part on the first frame, and the duration of the NAV protection may be equal to a duration of the first frame, a duration of the second frame, and a duration of two SIFS, where a first SIFS of the two SIFS is subsequent to the first frame and a second SIFS of the two SIFS is subsequent to the second frame. That is, the NAV protection duration may span from the ICF 602-a to the beginning of a first silent period (such as the NAV protection duration may include the duration for the ICF 602-a, a first SIFS duration after the ICF 602-a, the duration for the ICR 604-a, and its corresponding SIFS duration).

Additionally, or alternatively, a parameter in the second frame may indicate a second duration for providing NAV protection, and the second duration may be less than a channel switching threshold duration corresponding to transition between the first primary channel and the secondary primary channel. For example, the second duration of the NAV protection may be equal to a duration of the second frame and a duration of an SIFS, where the SIFS is subsequent to the second frame. That is, the NAV protection duration may span from the ICR 604-a to the beginning of the first NDPA (such as the NAV protection duration may include the duration for the ICR 604-a and its corresponding SIFS duration).

Based on using NAV protection in ICFs 602, ICRs 604, or both, the duration of the OBSS TXOP on the first primary channel may be shorter than the channel switching threshold duration, and the second STA 104-b may not switch to the secondary primary channel. That is, based on detecting the ICFs 602 or the ICRs 604 with NAV protection, the second STA 104-b may determine that the OBSS transmissions will occupy the first primary channel for a relatively short duration (such as less than the channel switching threshold duration), and may not switch to the secondary primary channel.

In a third example, a parameter of the one or more parameters may indicate, in the ICF 602-a, a second duration for providing NAV protection in the ICF 602-b. The second duration may include any silent periods that occur during the coordinated transmission messaging sequence. That is, the first AP 102-a may perform, based on transmission of the first frame and the one or more subsequent frames, the coordinated transmission messaging sequence with the second AP 102-b, and the coordinated transmission messaging sequence may include one or more silent periods between communication of respective frames. In some examples, the first AP 102-a may select the second duration to cover a longest possible silent period in all coordinated transmission messaging sequences.

Additionally, or alternatively, the first AP 102-a, the second AP 102-b, or both, may select the channel switching threshold duration such that the second duration indicated in the ICF 602-a is below the channel switching threshold duration. The channel switching threshold duration may correspond to a value used by a STA 104 to decide whether to switch to the secondary primary channel or not. If the second duration is less than the channel switching threshold duration, the STA 104 may not switch. Otherwise, the STA 104 may switch to the secondary primary channel. In some examples, the second STA 104-b may receive an indication of the channel switching threshold duration from the second AP 102-b. Based on receiving the ICF 602-a that indicates the second duration of the NAV protection, the second STA 104-b may not switch to the secondary primary channel while a coordinated transmission messaging sequence is occurring (such as ongoing or initiated by the first AP 102-a) while also ensuring that no other STAs 104 will attempt to access the medium during silent periods following ICF/ICR exchanges.

In the example of the signaling diagram 600, the second duration indicated in the ICF 602-a may cover until the beginning of the next frame transmitted by the first AP 102-a, which may be the CoBF trigger frame. The second duration may cover until the next transmitted frame because other STAs 104, such as the second STA 104-b, may not detect a response frame transmitted by a device other than the first AP 102-a (such as the ICR 604-a). The NAV protection may prevent other in-BSS clients jumping on the medium during silent periods that occur after ICF/ICR exchanges. Although described with reference to the signaling diagram 600, it is understood that the first AP 102-a may set the NAV protection duration for any frame to last until a next frame to be transmitted by the first AP 102-a.

In a fourth example, a parameter of the one or more parameters may indicate that a NPCA operation may be disallowed or disabled during the coordinated transmission messaging sequence by the first AP 102-a and the second AP 102-b (such as a CoBF frame exchange sequence). The NPCA operation may be associated with transition between the first primary channel and the secondary primary channel. In some examples, NPCA operation may be disallowed or disabled for one or more STAs 104 based on an indication that the NPCA operation is enabled at the one or more STAs. That is, the NPCA operation may be disallowed or disabled for NPCA-enabled clients (such as the second STA 104-b). In some other examples, NPCA operation may be disallowed or disabled for the first AP 102-a with respect to the second AP 102-b but may be allowed with respect to at least a third AP 102. That is, NPCA operation may be disallowed or disabled with respect to a set of OBSSs. For example, the second STA 104-b may not be allowed or enabled to perform NPCA operation if it detects OBSS transmissions from the first AP 102-a or from the second AP 102-b. However, the second STA 104-b may perform NPCA operation if it detects OBSS transmissions from a third AP 102.

The first AP 102-a may announce, via the first frame, when NPCA operation is disallowed or disabled if the AP 102-a expects to perform a coordinated transmission messaging procedure with the second AP 102-b. In some examples, the first AP 102-a may transmit, to the first STA 104-a via the first primary channel, a second frame indicating that the NPCA operation is allowed or enabled based on completion of the coordinated transmission messaging sequence. In some examples, the first frame may be a first beacon frame and the second frame may be a next beacon frame subsequent to the first beacon frame. The first AP 102-a may indicate that the NPCA operation is disallowed or disabled based on at least a portion of the coordinated transmission messaging sequence occurring in an interval between the first frame and the second frame. That is, the AP 102 may announce whether NPCA switching is allowed or enabled on a beacon-interval basis (for each beacon interval). In some other examples, the first frame may be a first management frame and the second frame may be a second management frame, and the first AP 102-a may indicate that the NPCA operation is disallowed or disabled based on at least a portion of the coordinated transmission messaging sequence occurring in an interval between the first frame and the second frame. That is, the first AP 102-a may announce the allowance or disallowance of NPCA in the first BSS using management frames (such as action frames).

Additionally, or alternatively, the first AP 102-a may indicate one or more SPs beginning at a first time and ending at a second time, and the indication that the NPCA operation is disallowed or disabled may be based on the coordinated transmission messaging sequence occurring within the one or more SPs. In some examples, the first AP 102-a may transmit TWT-based signaling to indicate the one or more SPs with coordinated transmission signaling sequences. That is, the first AP 102-a may indicate the one or more SPs using any signaling that may define the one or more SPs with one or more characteristics, parameters, or attributes (such as NPCA operation is disallowed or disabled during the one or more SPs). For example, the first AP 102-a may transmit one or more C-rTWT SPs.

In some examples, the first AP 102-a may disallow or disable NPCA operation during the coordinated transmission messaging sequence based on a set of one or more conditions being satisfied. For example, the first AP 102-a may indicate that NPCA operation is disallowed or disabled based on a specific coordinated transmission messaging sequence being enabled, such as a coordinated beamforming channel sounding sequence, a coordinated beamforming data transmission sequence, a coordinated spatial reuse sequence, or a coordinated beamforming time division multiple access sequence. Additionally, or alternatively, the first AP 102-a may disallow or disable NCPCA operation based on setting the one or more parameters such that the second STA 104-b may determine not to switch to the secondary primary channel. For example, the first AP 102-a may indicate a NAV protection shorter than the channel switching threshold duration such that the second STA 104-b does not switch to the secondary primary channel prior to receiving the ICF 602-b. In another example, the first AP 102-a may indicate that NPCA operation is disallowed or disabled using a parameter or field in a transmitted frame (such as in the ICF 602-a). In a third example, the first AP 102-a may indicate a set of APs 102 in which the second STA 104-b is allowed, or not allowed, to perform NPCA operation.

Although the signaling diagram 600 illustrates an example in which NPCA operation is disallowed or disabled by the APs 102 such as the first AP 102-a, it may be understood that the techniques described herein may apply to an example in which NPCA operation is disallowed or disabled by the STAs 104.

In a fifth example, an NPCA-enabled STA 104, such as the second STA 104-b, may delay its decision to switch to the secondary primary channel until the NPCA-enabled STA 104 receives a third OBSS PPDU (the second PPDU after the first detected OBSS PPDU), as part of the coordinated transmission messaging sequence. For example, the second STA 104-b may not switch to the secondary primary channel until reception of the ICF 602-b. Based on receiving the third PPDU, the second STA 104-b may begin processing the third PPDU. In some examples, the second STA 104-b may decode at least a first field of the third PPDU and determine whether to switch to the secondary primary channel based on decoding at least the first field. For example, the coordinated transmission messaging sequence may be an OBSS transmission sequence that includes ICF transmission, followed by ICR transmission, followed by transmission of the third PPDU.

In some examples, the first field of the third PPDU may be a HE-SIG-A field if the third PPDU is an HE-formatted PPDU, and the second STA 104-b may switch to the secondary primary channel. In some other examples, the first field of the third PPDU may be a U-SIG field if the third PPDU is an EHT-formatted PPDU. Based on being an HE-formatted PPDU or an EHT-formatted PPDU, the HE-SIG-A field or the U-SIG field may indicate a color of the BSS. That is, the first field may include an indication of which AP 102 transmitted the third PPDU. For example, the second STA 104-b may decode a first field of the PHY preamble in the third PPDU to determine whether the third PPDU is an in-BSS PPDU or an OBSS PPDU (whether the AP 102-b or the AP 102-a transmitted the third PPDU). The second STA 104-b may switch to the secondary primary channel if the third PPDU is an OBSS PPDU. That is, the STA 104-b may switch to the secondary primary channel if the first AP 102-a transmitted the third PPDU. Otherwise, such as if the third PPDU is an in-BSS PPDU transmitted by the second AP 102-b, or if it is not received after a threshold duration, the second STA 104-b may not switch.

In some other examples, the first field of the third PPDU may be a transmitter address (TA) field, receiver access (RA) field, or any combination thereof. The second AP 102-b may determine whether the third PPDU includes the HE-SIG-A field or the U-SIG field (such as if the third PPDU does not support HE or EHT formats). Additionally, or alternatively, second STA 104-b may decode the TA field, the RA field, or both, of the third PPDU to determine whether the third PPDU is an in-BSS transmission or an OBSS transmission if the BSS color field value in the HE-SIG-A field or in the U-SIG field is set to 0 or if the fields are not included in the frame. For example, the second STA 104-b may decode a MAC header in the third PPDU, and the MAC header may include the first field. The TA field, the RA field, or both, may indicate whether the third PPDU was transmitted by the second AP 102-b or another AP 102, such as the first AP 102-a. Based on whether the third PPDU is an in-BSS PPDU or an OBSS PPDU, the second STA 104-b may determine whether to switch to the O-Primary channel (e.g., the NPCA Primary channel). In some examples, the second STA 104-b may implement the fifth example for the CoBF transmission sequence (and not for the CoBF channel sounding sequence). In accordance with any of the examples described herein, the second STA 104-b may avoid switching to the secondary primary channel during a coordinated transmission messaging sequence, which may result in fewer failed coordinated transmission messaging sequences.

In a sixth example, the MU-BAR 608-a transmitted by the first AP 102-a may indicate a duration for providing NAV protection 612, and the duration may be less than a channel switching threshold duration corresponding to transition between the first primary channel and the secondary primary channel. NAV protection 612 may set the duration value of a frame to cover the duration of the response frame and two SIFS to ensure silencing other STAs 104 that may attempt to access the medium. For example, the first AP 102-a may receive the BA 610-a from the STA 104-a on the first primary channel in response to the MU-BAR 608-a, and the duration of the NAV protection 612 may be equal to a duration of the BA 610-a and a duration of two SIFS, where a first SIFS of the two SIFS is subsequent to the MU-BAR 608-a and a second SIFS of the two SIFS is subsequent to the BA 610-a. That is, the NAV protection 612 duration may include a first SIFS duration after the MU-BAR 608-a, the duration for the BA 610-a, and its corresponding SIFS duration.

In another example, the MU-BAR 608-b transmitted by the second AP 102-b may indicate a duration for providing NAV protection, and the duration may be less than a channel switching threshold duration corresponding to transition between the first primary channel and the secondary primary channel. The NAV protection may set the duration value of a frame to cover the duration of the response frame and a SIFS to silence other STAs 104 that may attempt to access the medium. For example, the second AP 102-b may receive the BA 610-b from the STA 104-b on the first primary channel in response to the MU-BAR 608-b, and the duration of the NAV protection may be equal to a duration of the BA 610-b and a duration of a SIF, where the SIF is subsequent to the MU-BAR 608-b.

Based on using NAV protection 612 in the MU-BAR 608-a, the duration of the OBSS TXOP on the first primary channel may be shorter than the channel switching threshold duration, and the second STA 104-b may not switch to the secondary primary channel. That is, based on detecting the MU-BAR 608-a with NAV protection 612, the second STA 104-b may determine that the OBSS transmissions will occupy the first primary channel for a relatively short duration (such as less than the channel switching threshold duration), and may not switch to the secondary primary channel.

In a seventh example, the coordinated transmission messaging sequence may be a CoBF operation, and the APs 102 may determine to not operate in CoBF. As described with reference to FIG. 2, a CoBF operation may be divided into a channel sounding phase and a data transmission phase. In some examples, the coordinated transmission messaging sequence may be a channel sounding sequence (e.g., the channel sounding phase of the CoBF operation), and the APs 102 may reject an invitation to perform the channel sounding sequence. For example, the AP 102-a may transmit a sounding invite to the AP 102-b inviting the AP 102-b to perform the channel sounding sequence and may monitor for a sounding response from the AP 102-b. The sounding response from the AP 102-b may indicate whether the AP 102-b accepts or rejects the sounding invite. The AP 102-b may reject the sounding invite based on determining to not operate in CoBF. For example, the AP 102-b may reject the sounding invite if a CoBF agreement has been established between the AP 102-b and another AP 102 (not illustrated). For example, the AP 102-b may transmit a rejection frame to reject the CoBF invitation.

In some other examples, the coordinated transmission messaging sequence may be a CoBF transmission sequence (e.g., the data transmission phase of the CoBF operation), and the APs 102 may reject an invitation to perform the CoBF transmission sequence. For example, the AP 102-a may transmit a CoBF invite to the AP 102-b inviting the AP 102-b to perform the CoBF transmission sequence and may monitor for a CoBF response from the AP 102-b. The CoBF response from the AP 102-b may indicate whether the AP 102-b accepts or rejects the CoBF invite. The AP 102-b may reject the CoBF invite based on determining to not operate in CoBF. For example, the AP 102-b may reject the CoBF invite if a CoBF agreement has been established between the AP 102-b and another AP 102 (not illustrated). For example, the AP 102-b may transmit a rejection frame to AP 102-a to reject the CoBF invitation.

Additionally, or alternatively, in some examples, the APs 102 may determine not to establish any CoBF multi-AP coordination (MAPC) agreements during a MAPC agreement establishment phase. In some other examples, CoBF may be disabled by the STAs 104 (e.g., via transmission of one or more frames such as a rejection frame to an AP 102).

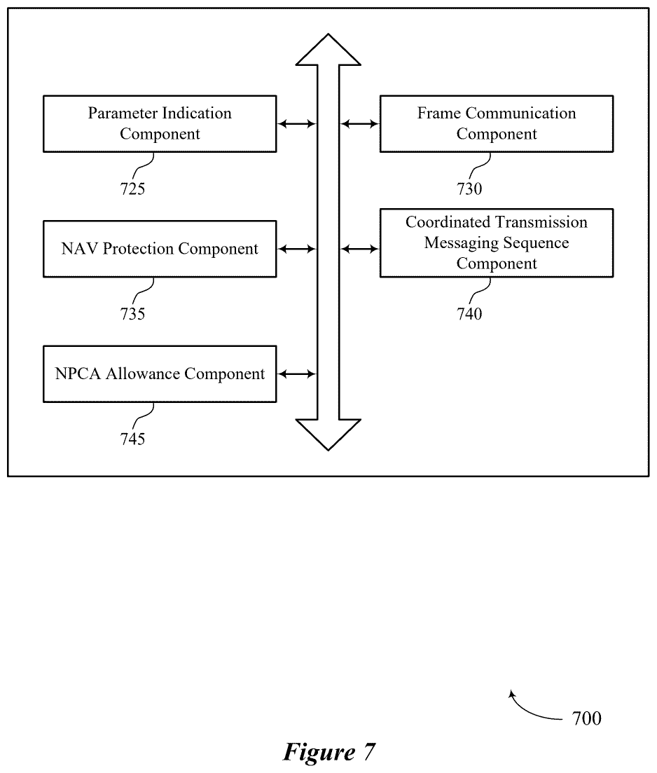

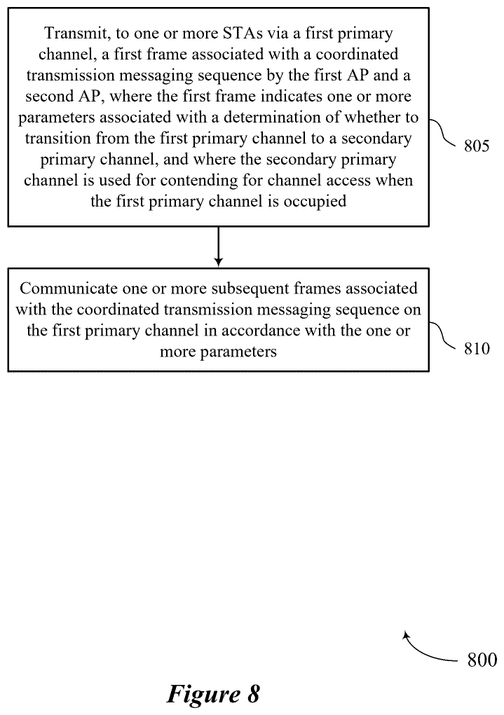

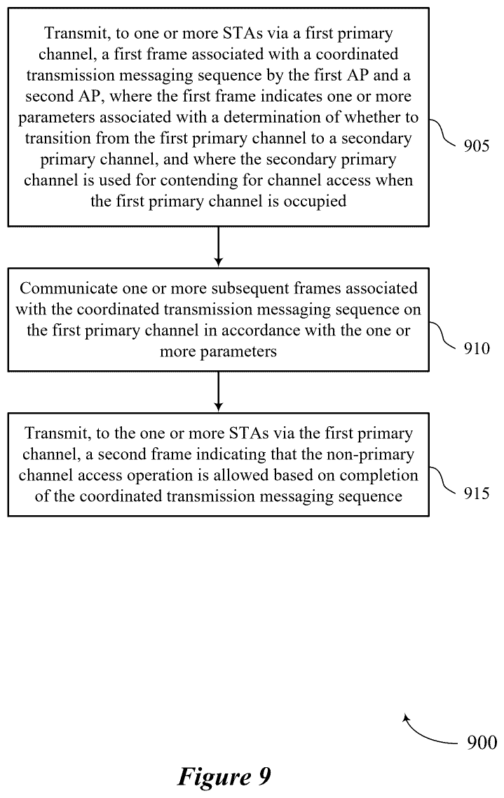

FIG. 7 shows a block diagram of an example wireless communication device 700 that supports NPCA conditions for joint operation with coordinated AP procedures. In some examples, the wireless communication device 700 is configured to perform the processes 800 and 900 described with reference to FIGS. 8 and 9, respectively. The wireless communication device 700 may include one or more chips, SoCs, chipsets, packages, components or devices that individually or collectively constitute or include a processing system. The processing system may interface with other components of the wireless communication device 700, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 700 may transmit the information output from the chip. In such an example, the second interface may refer to an interface between the processing system of the chip and a reception component, such that the wireless communication device 700 may receive information that is then passed to the processing system. In some such examples, the first interface also may obtain information, such as from the transmission component, and the second interface also may output information, such as to the reception component.

The processing system of the wireless communication device 700 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 700 can be configurable or configured for use in an AP, such as the AP 102 described with reference to FIG. 1. In some other examples, the wireless communication device 700 can be an AP that includes such a processing system and other components including multiple antennas. The wireless communication device 700 is capable of transmitting and receiving wireless communications in the form of, for example, wireless packets. For example, the wireless communication device 700 can be configurable or configured to transmit and receive packets in the form of physical layer PPDUs and MPDUs conforming to one or more of the IEEE 802.11 family of wireless communication protocol standards. In some other examples, the wireless communication device 700 can be configurable or configured to transmit and receive signals and communications conforming to one or more 3GPP specifications including those for 5G NR or 6G. In some examples, the wireless communication device 700 also includes or can be coupled with one or more application processors which may be further coupled with one or more other memories. In some examples, the wireless communication device 700 further includes at least one external network interface coupled with the processing system that enables communication with a core network or backhaul network that enables the wireless communication device 700 to gain access to external networks including the Internet.

The wireless communication device 700 includes a parameter indication component 725, a frame communication component 730, a NAV protection component 735, a coordinated transmission messaging sequence component 740, and an NPCA allowance component 745. Portions of one or more of the parameter indication component 725, the frame communication component 730, the NAV protection component 735, the coordinated transmission messaging sequence component 740, and the NPCA allowance component 745 may be implemented at least in part in hardware or firmware. For example, one or more of the parameter indication component 725, the frame communication component 730, the NAV protection component 735, the coordinated transmission messaging sequence component 740, and the NPCA allowance component 745 may be implemented at least in part by at least a processor or a modem. In some examples, portions of one or more of the parameter indication component 725, the frame communication component 730, the NAV protection component 735, the coordinated transmission messaging sequence component 740, and the NPCA allowance component 745 may be implemented at least in part by a processor and software in the form of processor-executable code stored in memory.

The wireless communication device 700 may support wireless communications in accordance with examples as disclosed herein. The parameter indication component 725 is configurable or configured to transmit, to one or more stations (STAs) via a first primary channel, a first frame associated with a coordinated transmission messaging sequence by the first AP and a second AP, where the first frame indicates one or more parameters associated with a determination of whether to transition from the first primary channel to a secondary primary channel, and where the secondary primary channel is used for contending for channel access when the first primary channel is occupied. The frame communication component 730 is configurable or configured to communicate one or more subsequent frames associated with the coordinated transmission messaging sequence on the first primary channel in accordance with the one or more parameters.

In some examples, a first parameter of the one or more parameters indicates a first duration for providing network allocation vector protection. In some examples, the first duration is less than a channel switching threshold duration corresponding to transition between the first primary channel and the secondary primary channel.

In some examples, to communicate the one or more subsequent frames, the NAV protection component 735 is configurable or configured to receive a second frame on the first primary channel based on the first frame, where the second frame indicates a second duration for providing network allocation vector protection, where the first duration for providing network allocation vector protection is equal to a second duration of the first frame, a third duration of the second frame, and a fourth duration of two short interframe spacings, a first short interframe spacing of the two short interframe spacings subsequent to the first frame and a second short interframe spacing of the two short interframe spacings subsequent to the second frame, and where the second duration for providing network allocation vector protection is equal to the third duration of the second frame and a fifth duration of the second short interframe spacing. In some examples, the first frame is an initial control frame and the second frame is an initial control response.

In some examples, to communicate the one or more subsequent frames, the NAV protection component 735 is configurable or configured to transmit, to the one or more STAs via the first primary channel, a multi-user block acknowledgment request corresponding to a downlink data transmission of the coordinated transmission messaging sequence, the multi-user block acknowledgment request indicating a first duration of network allocation vector protection, and to monitor the first primary channel for a block acknowledgment responsive to the multi-user block acknowledgment request.

In some examples, the coordinated transmission messaging sequence component 740 is configurable or configured to perform, based on transmission of the first frame and the one or more subsequent frames, the coordinated transmission messaging sequence with the second AP, where the coordinated transmission messaging sequence includes one or more silent periods between communication of respective frames.

In some examples, a first parameter of the one or more parameters indicates a first bandwidth associated with the coordinated transmission messaging sequence that includes the first primary channel and the secondary primary channel. In some examples, the one or more subsequent frames are communicated via the first bandwidth or via a second bandwidth that differs from the first bandwidth. In some examples, the one or more subsequent frames span an entirety of the first primary channel and the secondary primary channel. In some examples, the second bandwidth is less than the first bandwidth. In some examples, the first frame is an initial control frame and the one or more subsequent frames include an initial control response. In some examples, a first parameter of the one or more parameters includes an indication that a non-primary channel access operation is disallowed or disabled during the coordinated transmission messaging sequence by the first AP and the second AP, the non-primary channel access operation associated with transition between the first primary channel and the secondary primary channel. In some examples, the NPCA allowance component 745 is configurable or configured to transmit, to the one or more STAs via the first primary channel, a second frame including an indication that the non-primary channel access operation is allowed or enabled based on completion of the coordinated transmission messaging sequence.

In some examples, the first frame is a first beacon frame and the second frame is a next beacon frame subsequent to the first beacon frame. In some examples, the indication that the non-primary channel access operation is disallowed or disabled is based on at least a portion of the coordinated transmission messaging sequence occurring in an interval between the first frame and the second frame. In some examples, the first frame is a first management frame and the second frame is a second management frame. In some examples, the indication that the non-primary channel access operation is disallowed or disabled is based on at least a portion of the coordinated transmission messaging sequence occurring in an interval between the first frame and the second frame. In some examples, the first frame further indicates a service period beginning at a first time and ending at a second time. In some examples, the indication that the non-primary channel access operation is disallowed or disabled is based on the coordinated transmission messaging sequence occurring within the service period.

In some examples, the non-primary channel access operation is disallowed or disabled during the coordinated transmission messaging sequence based on a set of one or more conditions being satisfied, where the coordinated transmission messaging sequence that is enabled is a coordinated beamforming channel sounding sequence, a coordinated beamforming data transmission sequence, a coordinated spatial reuse sequence, a coordinated beamforming time division multiple access sequence, or any combination thereof. In some examples, the non-primary channel access operation is disallowed or disabled for the one or more STAs based on an indication that the non-primary channel access operation is enabled at the one or more STAs. In some examples, the non-primary channel access operation is disallowed or disabled for the first AP and the second AP of a first OBSS and allowed for at least a third AP of a second OBSS.

In some examples, the coordinated transmission messaging sequence is a coordinated beamforming channel sounding sequence or a coordinated beamforming data transmission sequence, and the frame communication component 740 is configurable or configured to transmit, to the second AP, an invitation to perform the coordinated beamforming channel sounding sequence or the coordinated beamforming data transmission sequence, and to monitor for a response indicating an acceptance or a rejection of the invitation.

In some examples, the transition from the first primary channel to the secondary primary channel is delayed until after reception of an initial control frame, an initial control response frame, and a third frame.

In some examples, the coordinated transmission messaging sequence is a coordinated beamforming channel sounding sequence, a coordinated beamforming data transmission sequence, a coordinated spatial reuse sequence, or any combination thereof.

FIG. 8 shows a flowchart illustrating an example process 800 performable by or at a first AP that supports NPCA conditions for joint operation with coordinated AP procedures. The operations of the process 800 may be implemented by a first AP or its components as described herein. For example, the process 800 may be performed by a wireless communication device, such as the wireless communication device 700 described with reference to FIG. 7, operating as or within a wireless AP. In some examples, the process 800 may be performed by a wireless AP, such as one of the APs 102 described with reference to FIG. 1.

In some examples, in 805, the first AP may transmit, to one or more stations (STAs) via a first primary channel, a first frame associated with a coordinated transmission messaging sequence by the first AP and a second AP, where the first frame indicates one or more parameters associated with a determination of whether to transition from the first primary channel to a secondary primary channel, and where the secondary primary channel is used for contending for channel access when the first primary channel is occupied. The operations of 805 may be performed in accordance with examples as disclosed herein. In some implementations, aspects of the operations of 805 may be performed by a parameter indication component 725 as described with reference to FIG. 7.

In some examples, in 810, the first AP may communicate one or more subsequent frames associated with the coordinated transmission messaging sequence on the first primary channel in accordance with the one or more parameters. The operations of 810 may be performed in accordance with examples as disclosed herein. In some implementations, aspects of the operations of 810 may be performed by a frame communication component 730 as described with reference to FIG. 7.

FIG. 9 shows a flowchart illustrating an example process 900 performable by or at a first AP that supports NPCA conditions for joint operation with coordinated AP procedures. The operations of the process 900 may be implemented by a first AP or its components as described herein. For example, the process 900 may be performed by a wireless communication device, such as the wireless communication device 700 described with reference to FIG. 7, operating as or within a wireless AP. In some examples, the process 900 may be performed by a wireless AP, such as one of the APs 102 described with reference to FIG. 1.

In some examples, in 905, the first AP may transmit, to one or more STAs via a first primary channel, a first frame associated with a coordinated transmission messaging sequence by the first AP and a second AP, where the first frame indicates one or more parameters associated with a determination of whether to transition from the first primary channel to a secondary primary channel, and where the secondary primary channel is used for contending for channel access when the first primary channel is occupied. The operations of 905 may be performed in accordance with examples as disclosed herein. In some implementations, aspects of the operations of 905 may be performed by a parameter indication component 725 as described with reference to FIG. 7.

In some examples, in 910, the first AP may communicate one or more subsequent frames associated with the coordinated transmission messaging sequence on the first primary channel in accordance with the one or more parameters. The operations of 910 may be performed in accordance with examples as disclosed herein. In some implementations, aspects of the operations of 910 may be performed by a frame communication component 730 as described with reference to FIG. 7.

In some examples, in 915, the first AP may transmit, to the one or more STAs via the first primary channel, a second frame including an indication that the non-primary channel access operation is allowed based on completion of the coordinated transmission messaging sequence. The operations of 915 may be performed in accordance with examples as disclosed herein. In some implementations, aspects of the operations of 915 may be performed by an NPCA allowance component 745 as described with reference to FIG. 7.

Implementation examples are described in the following numbered clauses:
Aspect 1: A method for wireless communications at a first AP, comprising: transmitting, to one or more stations (STAs) via a first primary channel, a first frame associated with a coordinated transmission messaging sequence by the first AP and a second AP, wherein the first frame indicates one or more parameters associated with a determination of whether to transition from the first primary channel to a secondary primary channel, and wherein the secondary primary channel is used for contending for channel access when the first primary channel is occupied; and communicating one or more subsequent frames associated with the coordinated transmission messaging sequence on the first primary channel in accordance with the one or more parameters.
Aspect 2: The method of aspect 1, wherein a first parameter of the one or more parameters indicates a first duration for providing network allocation vector protection, and the first duration is less than a channel switching threshold duration corresponding to transition between the first primary channel and the secondary primary channel.
Aspect 3: The method of aspect 2, wherein communicating the one or more subsequent frames further comprises: receiving a second frame on the first primary channel based at least in part on the first frame, wherein the second frame indicates a second duration for providing network allocation vector protection, wherein the first duration for providing network allocation vector protection is equal to a second duration of the first frame, a third duration of the second frame, and a fourth duration of two short interframe spacings, a first short interframe spacing of the two short interframe spacings subsequent to the first frame and a second short interframe spacing of the two short interframe spacings subsequent to the second frame, and wherein the second duration for providing network allocation vector protection is equal to the third duration of the second frame and a fifth duration of the second short interframe spacing.
Aspect 4: The method of aspect 3, wherein the first frame is an initial control frame and the second frame is an initial control response.
Aspect 5: The method of any of aspects 2 through 4, further comprising: performing, based at least in part on transmission of the first frame and the one or more subsequent frames, the coordinated transmission messaging sequence with the second AP, wherein the coordinated transmission messaging sequence comprises one or more silent periods between communication of respective frames.
Aspect 6: The method of aspect 1, wherein a first parameter of the one or more parameters indicates a first bandwidth associated with the coordinated transmission messaging sequence that comprises the first primary channel and the secondary primary channel, and the one or more subsequent frames are communicated via the first bandwidth or via a second bandwidth that differs from the first bandwidth.
Aspect 7: The method of aspect 6, wherein the one or more subsequent frames span an entirety of the first primary channel and the secondary primary channel.
Aspect 8: The method of any of aspects 6 through 7, wherein the second bandwidth is less than the first bandwidth.
Aspect 9: The method of any of aspects 6 through 8, wherein the first frame is an initial control frame and the one or more subsequent frames comprise an initial control response.
Aspect 10: The method of aspect 1, wherein a first parameter of the one or more parameters includes an indication that a non-primary channel access operation is disallowed or disabled during the coordinated transmission messaging sequence by the first AP and the second AP, the non-primary channel access operation associated with transition between the first primary channel and the secondary primary channel.
Aspect 11: The method of aspect 10, further comprising: transmitting, to the one or more STAs via the first primary channel, a second frame including an indication that the non-primary channel access operation is allowed or enabled based at least in part on completion of the coordinated transmission messaging sequence.
Aspect 12: The method of aspect 11, wherein the first frame is a first beacon frame and the second frame is a next beacon frame subsequent to the first beacon frame, and the indication that the non-primary channel access operation is disallowed or disabled is based at least in part on at least a portion of the coordinated transmission messaging sequence occurring in an interval between the first frame and the second frame.
Aspect 13: The method of any of aspects 11 through 12, wherein the first frame is a first management frame and the second frame is a second management frame, and the indication that the non-primary channel access operation is disallowed or disabled is based at least in part on at least a portion of the coordinated transmission messaging sequence occurring in an interval between the first frame and the second frame.
Aspect 14: The method of any of aspects 10 through 13, wherein the first frame further indicates a service period beginning at a first time and ending at a second time, and the indication that the non-primary channel access operation is disallowed or disabled is based at least in part on the coordinated transmission messaging sequence occurring within the service period.
Aspect 15: The method of any of aspects 10 through 14, wherein the non-primary channel access operation is disallowed or disabled during the coordinated transmission messaging sequence based at least in part on a set of one or more conditions being satisfied, wherein the coordinated transmission messaging sequence that is enabled is a coordinated beamforming channel sounding sequence, a coordinated beamforming data transmission sequence, a coordinated spatial reuse sequence, a coordinated beamforming time division multiple access sequence, or any combination thereof.
Aspect 16: The method of any of aspects 10 through 15, wherein the non-primary channel access operation is disallowed or disabled for the one or more STAs based at least in part on an indication that the non-primary channel access operation is enabled at the one or more STAs.
Aspect 17: The method of any of aspects 10 through 16, wherein the non-primary channel access operation is disallowed or disabled for the first AP and the second AP of a first overlapping BSS (OBSS) and allowed or enabled for at least a third AP of a second OBSS.
Aspect 18: The method of aspect 1, further comprising: transmitting, to the one or more STAs via the first primary channel, a multi-user block acknowledgment request corresponding to a downlink data transmission of the coordinated transmission messaging sequence, the multi-user block acknowledgment request indicating a first duration of network allocation vector protection; and monitoring the first primary channel for a block acknowledgment responsive to the multi-user block acknowledgment request.
Aspect 19: The method of aspect 1, wherein the coordinated transmission messaging sequence is a coordinated beamforming channel sounding sequence or a coordinated beamforming data transmission sequence, the method further comprising: transmitting, to the second AP, an invitation to perform the coordinated beamforming channel sounding sequence or the coordinated beamforming data transmission sequence; and monitoring for a response indicating an acceptance or a rejection of the invitation.
Aspect 20: The method of aspect 1, wherein the transition from the first primary channel to the secondary primary channel is delayed until after reception of an initial control frame, an initial control response frame, and a third frame.
Aspect 21: The method of any of aspects 1 through 20, wherein the coordinated transmission messaging sequence is a coordinated beamforming channel sounding sequence, a coordinated beamforming data transmission sequence, a coordinated spatial reuse sequence, or any combination thereof.
Aspect 22: A first AP for wireless communications, comprising one or more memories storing processor-executable code, and one or more processors coupled with the one or more memories and individually or collectively operable to execute the code to cause the first AP to perform a method of any of aspects 1 through 21.
Aspect 23: A first AP for wireless communications, comprising at least one means for performing a method of any of aspects 1 through 21.
Aspect 24: A non-transitory computer-readable medium storing code for wireless communications, the code comprising instructions executable by one or more processors to perform a method of any of aspects 1 through 21.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset”refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first access point (AP), comprising:
a processing system that includes processor circuitry and memory circuitry that stores code, the processing system configured to cause the first AP to:
transmit, to one or more stations (STAs) via a first primary channel, a first frame associated with a coordinated transmission messaging sequence by the first AP and a second AP, wherein the first frame indicates one or more parameters associated with a determination of whether to transition from the first primary channel to a secondary primary channel, and wherein the secondary primary channel is used for contending for channel access when the first primary channel is occupied; and
communicate one or more subsequent frames associated with the coordinated transmission messaging sequence on the first primary channel in accordance with the one or more parameters.

2. The first AP of claim 1, wherein:
a first parameter of the one or more parameters indicates a first duration for providing network allocation vector protection, and
the first duration is less than a channel switching threshold duration corresponding to transition between the first primary channel and the secondary primary channel.

3. The first AP of claim 2, wherein, to communicate the one or more subsequent frames, the processing system is further configured to cause the first AP to:
receive a second frame on the first primary channel based at least in part on the first frame, wherein the second frame indicates a second duration for providing network allocation vector protection, wherein the first duration for providing network allocation vector protection is equal to a second duration of the first frame, a third duration of the second frame, and a fourth duration of two short interframe spacings, a first short interframe spacing of the two short interframe spacings subsequent to the first frame and a second short interframe spacing of the two short interframe spacings subsequent to the second frame, and wherein the second duration for providing network allocation vector protection is equal to the third duration of the second frame and a fifth duration of the second short interframe spacing.

4. The first AP of claim 3, wherein the first frame is an initial control frame and the second frame is an initial control response.

5. The first AP of claim 1, wherein the processing system is further configured to cause the first AP to:
transmit, to the one or more STAs via the first primary channel, a multi-user block acknowledgment request corresponding to a downlink data transmission of the coordinated transmission messaging sequence, the multi-user block acknowledgment request indicating a first duration of network allocation vector protection; and
monitor the first primary channel for a block acknowledgement responsive to the multi-user block acknowledgment request.

6. The first AP of claim 1, wherein a first parameter of the one or more parameters includes an indication that a non-primary channel access operation is disallowed or disabled during the coordinated transmission messaging sequence by the first AP and the second AP, the non-primary channel access operation associated with transition between the first primary channel and the secondary primary channel.

7. The first AP of claim 6, wherein the processing system is further configured to cause the first AP to:
transmit, to the one or more STAs via the first primary channel, a second frame including an indication that the non-primary channel access operation is allowed or enabled based at least in part on completion of the coordinated transmission messaging sequence.

8. The first AP of claim 7, wherein:
the first frame is a first beacon frame and the second frame is a next beacon frame subsequent to the first beacon frame, and
the indication that the non-primary channel access operation is disallowed or disabled is based at least in part on at least a portion of the coordinated transmission messaging sequence occurring in an interval between the first frame and the second frame.

9. The first AP of claim 7, wherein:
the first frame is a first management frame and the second frame is a second management frame, and
the indication that the non-primary channel access operation is disallowed or disabled is based at least in part on at least a portion of the coordinated transmission messaging sequence occurring in an interval between the first frame and the second frame.

10. The first AP of claim 6, wherein:
the first frame further indicates a service period beginning at a first time and ending at a second time, and
the indication that the non-primary channel access operation is disallowed or disabled is based at least in part on the coordinated transmission messaging sequence occurring within the service period.

11. The first AP of claim 6, wherein the non-primary channel access operation is disallowed or disabled during the coordinated transmission messaging sequence based at least in part on a set of one or more conditions being satisfied, wherein the coordinated transmission messaging sequence that is enabled is a coordinated beamforming channel sounding sequence, a coordinated beamforming data transmission sequence, a coordinated spatial reuse sequence, a coordinated beamforming time division multiple access sequence, or any combination thereof.

12. The first AP of claim 6, wherein the non-primary channel access operation is disallowed or disabled for the one or more STAs based at least in part on an indication that the non-primary channel access operation is enabled at the one or more STAs.

13. The first AP of claim 6, wherein the non-primary channel access operation is disallowed or disabled for the first AP and the second AP of a first overlapping BSS (OBSS) and allowed or enabled for at least a third AP of a second OBSS.

14. The first AP of claim 1, wherein the coordinated transmission messaging sequence is a coordinated beamforming channel sounding sequence or a coordinated beamforming data transmission sequence, and wherein the processing system is further configured to cause the first AP to:
transmit, to the second AP, an invitation to perform the coordinated beamforming channel sounding sequence or the coordinated beamforming data transmission sequence; and
monitor for a response indicating an acceptance or a rejection of the invitation.

15. The first AP of claim 1, wherein the coordinated transmission messaging sequence is a coordinated beamforming channel sounding sequence, a coordinated beamforming data transmission sequence, a coordinated spatial reuse sequence, or any combination thereof.

16. The first AP of claim 1, wherein the transition from the first primary channel to the secondary primary channel is delayed until after reception of an initial control frame, an initial control response frame, and a third frame.

17. A method for wireless communications at a first access point (AP), comprising:
transmitting, to one or more stations (STAs) via a first primary channel, a first frame associated with a coordinated transmission messaging sequence by the first AP and a second AP, wherein the first frame indicates one or more parameters associated with a determination of whether to transition from the first primary channel to a secondary primary channel, and wherein the secondary primary channel is used for contending for channel access when the first primary channel is occupied; and
communicating one or more subsequent frames associated with the coordinated transmission messaging sequence on the first primary channel in accordance with the one or more parameters.

18. The method of claim 17, wherein:
a first parameter of the one or more parameters indicates a first duration for providing network allocation vector protection, and
the first duration is less than a channel switching threshold duration corresponding to transition between the first primary channel and the secondary primary channel.

19. The method of claim 18, wherein communicating the one or more subsequent frames further comprises:
receiving a second frame on the first primary channel based at least in part on the first frame, wherein the second frame indicates a second duration for providing network allocation vector protection, wherein the first duration for providing network allocation vector protection is equal to a second duration of the first frame, a third duration of the second frame and a fourth duration of two short interframe spacings, a first short interframe spacing of the two short interframe spacings subsequent to the first frame and a second short interframe spacing of the two short interframe spacings subsequent to the second frame, and wherein the second duration for providing network allocation vector protection is equal to the third duration of the second frame and a fifth duration of the second short interframe spacing.

20. A non-transitory computer-readable medium storing code for wireless communications, the code comprising instructions executable by one or more processors to:
transmit, to one or more stations (STAs) via a first primary channel, a first frame associated with a coordinated transmission messaging sequence by a first access point (AP) and a second AP, wherein the first frame indicates one or more parameters associated with a determination of whether to transition from the first primary channel to a secondary primary channel, and wherein the secondary primary channel is used for contending for channel access when the first primary channel is occupied; and
communicate one or more subsequent frames associated with the coordinated transmission messaging sequence on the first primary channel in accordance with the one or more parameters.
